(19) United States
(12) Patent Application Publication
(10) Pub. No.: US 2020/0132494 A1
(43) Pub. Date: Apr. 30, 2020

(54) DATA GENERATING APPARATUS, DATA GENERATING SYSTEM, DATA GENERATION METHOD, AND NON-TRANSITORY RECORDING MEDIUM

(71) Applicant: TOYOTA JIDOSHA KABUSHIKI KAISHA, Toyota-shi (JP)

(72) Inventors: Hiroshi MAJIMA, Tokyo-to (JP); Nariaki AMANO, Nagoya-shi (JP); Yukiya YAMANE, Tokyo-to (JP); Kazuki KATO, Kawaguchi-shi (JP)

(73) Assignee: TOYOTA JIDOSHA KABUSHIKI KAISHA, Toyota-shi (JP)

(21) Appl. No.: 16/654,310

(22) Filed: Oct. 16, 2019

(30) Foreign Application Priority Data
Oct. 30, 2018 (JP) 2018-204544

(51) Int. Cl. G01C 21/36; G01C 21/34

(52) U.S. Cl. CPC G01C 21/3617; G01C 21/3484; G01C 21/3438; G01C 21/3423

(57) ABSTRACT

On a basis of history information of route search results using particular types of transportation, a first type of rates of the particular types of transportation being used in route candidates of each of route search results and a second type of rates of the particular types of transportation being used in route candidates each selected by a user from among the route candidates provided in each of the route search results are calculated on a per-type of transportation basis and on a per-combination of departure point area and destination area basis. Data is generated, on the per-combination of departure point area and destination area basis, where the departure point areas and the destination areas are associated with, on the per-type of transportation basis, the at least one type of rates from among the first type of rates and the second type of rates.

### BACKGROUND OF THE INVENTION

### 1. Field of the Invention

The present invention relates to a data generating apparatus, a data generating system, a data generation method, and a non-transitory recording medium.

### 2. Description of the Related Art

In the related art, a navigation apparatus is known that implements a multimodal route search for a route from a departure point to a destination using one or more types of transportation from among a plurality of types of transportation such as a car, walking, a bicycle, public transportation, and so forth (for example, see Japanese Laid-Open Patent Application No. 2012-167994).

### SUMMARY OF THE INVENTION

In one embodiment of the present invention, a data generating apparatus includes one or more processors configured to calculate,

on a basis of stored history information of route search results of route searches from departure points to destinations, each using one or more types of transportation from among a plurality of types of transportation, performed in response to route search requests respectively from a plurality of users and each including a departure point and a destination,

at least one type of rates from among a first type of rates and a second type of rates, each type of rates being rates with respect to route search requests corresponding to combinations of departure point areas and destination areas,

wherein

the first type of rates are respective rates of, on a per-combination of departure point area and destination area basis and on a per-type of transportation basis, the types of transportation being used in route candidates provided in each of route search results, and

the second type of rates are respective rates of, on the per-combination of departure point area and destination area basis and on the per-type of transportation basis, the types of transportation being used in route candidates each selected by a user from the route candidates provided in each of the route search results; and

generate, on the per-combination of departure point area and destination area basis, data where the departure point areas and the destination areas are associated with, on the per-type of transportation basis, the at least one type of rates from among the first type of rates and the second type of rates.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating an example of a configuration of a multimodal route providing system according to an embodiment;

FIG. 2 is a configuration diagram illustrating an example of a hardware configuration of a center server;

FIG. 3 is a functional block diagram illustrating an example of a functional configuration of the center server and a mobile terminal;

FIGS. 4, 5A, 5B, and 6A-6C illustrate examples of user's operation for requesting a multimodal route search;

FIG. 7 illustrates an example of a setting screen page for setting predetermined types of transportation for multimodal route searches;

FIGS. 8A and 8B illustrate examples of a display screen page of a multimodal route search result;

FIG. 9 illustrates an example of a method of determining predetermined types of transportation to be displayed in association with a route candidate;

FIGS. 10A and 10B illustrate examples of a method to use a taxi on the basis of a multimodal route search result;

FIGS. 11A and 11B illustrate examples of a viewing method for parking area information based on a multimodal route search result;

FIGS. 12A and 12B illustrate examples of a method to use bicycle sharing on the basis of a multimodal route search result;

FIGS. 13A and 13B illustrate examples of a method for viewing fixed route bus location information and a method for purchasing and using a fixed route bus ticket on the basis of a multimodal route search result;

FIGS. 14A and 14B are flowcharts schematically illustrating an example of a fixed route bus ticket information display process with a mobile terminal (a fixed route bus ticket usage assist process unit);

FIGS. 15A and 15B illustrate examples of history data of multimodal route search results; and

FIGS. 16A-16D illustrate methods of generating macro data.

### DETAILED DESCRIPTION OF THE EMBODIMENTS

Various tendencies on users' moving may be known from a macro viewpoint from a set of raw data of route search results obtained from multimodal route searches performed in response to the users' requests.

However, raw data associated with particular route search results merely provide schedules of users for particular time points. Therefore, it would be convenient if there were a method for generating output data for knowing particular tendencies of users' moving from a macro viewpoint from raw data of route search results.

An object of an embodiment of the present invention is to provide, for example, a data generating apparatus capable of generating output data with which various tendencies of users' moving can be known from a macro viewpoint from history data of multimodal route search results to route search requests from a plurality of users.

In one embodiment of the present invention, a data generating apparatus includes one or more processors configured to calculate,

on a basis of stored history information of route search results from departure points to destinations, each using one or more types of transportation from among a plurality of types of transportation, performed in response to route search requests respectively from a plurality of users and each request including a departure point and a destination,

at least one type of rates from among a first type of rates and a second type of rates, each type of rates being rates with respect to route search requests corresponding to combinations of departure point areas and destination areas and being calculated on a per-combination of departure point area and destination area basis and on a per-type of transportation basis,

wherein

the first type of rates are rates of the particular types of transportation being used in route candidates provided in each of route search results, and

the second type of rates are rates of the particular types of transportation being used in route candidates each selected by a user from among the route candidates provided in each of the route search results; and

generate, on the per-combination of departure point area and destination area basis, data where the departure point areas and the destination areas are associated with, on the per-type of transportation basis, the at least one type of rates from among the first type of rates and the second type of rates.

According to the embodiment, the data generating apparatus can generate macro data corresponding to extents to which particular types of transportation can support needs to move a plurality of users from departure point areas to destination areas. The data generating apparatus can also generate macro data as to which types of transportation users tend to select for their needs to move from departure point areas to destination areas. Thus, the data generating apparatus can generate output data (macro data) for enabling to know various tendencies concerning moving of users from a macro viewpoint from history data of multimodal route search results corresponding to requests from the users.

In the above-described embodiment, the data generating apparatus may generate, on the per-combination of departure point area and destination area basis, macro data where the departure point areas and the destination areas are associated with, on the per-type of transportation basis, information concerning attributes of users who have selected the plurality of types of transportation that have been selected from the route search results of the group of route search requests corresponding to the combinations of the departure point areas and the destination areas.

According to the embodiment, the data generating apparatus can generate macro data for attributes of users who have selected particular types of transportation for a plurality of needs to move from departure point areas to destination areas.

In the above-described embodiment, the information concerning the attributes of the users who have selected the types of transportation that have been selected from the route search results of the group of route search requests corresponding to the combinations of departure point areas and destination areas, may include information concerning a set of rates from among a set of genders, a set of ages, a set of living areas, a set of states of having and not having cars, and a set of states of having and not having commuter tickets from departure point areas to destination areas of corresponding types of transportation.

According to the embodiment, the data generating apparatus can generate, on a per-particular user attribute classification basis, macro data as to attributes of users who have selected particular types of transportation for a plurality of needs to move from departure point areas to destination areas.

Other embodiments of the present invention may also be implemented as a data generating system, a data generating method, and a non-transitory recording medium.

According to the above-described embodiments, the data generating apparatus and so forth capable of generating output data for enabling to know various tendencies of users' moving from a macro viewpoint from history data of multimodal route search results corresponding to requests from a plurality of users can be provided.

Below, embodiments of the present invention will be described later in more detail with reference to the drawings.

### [System Overview]

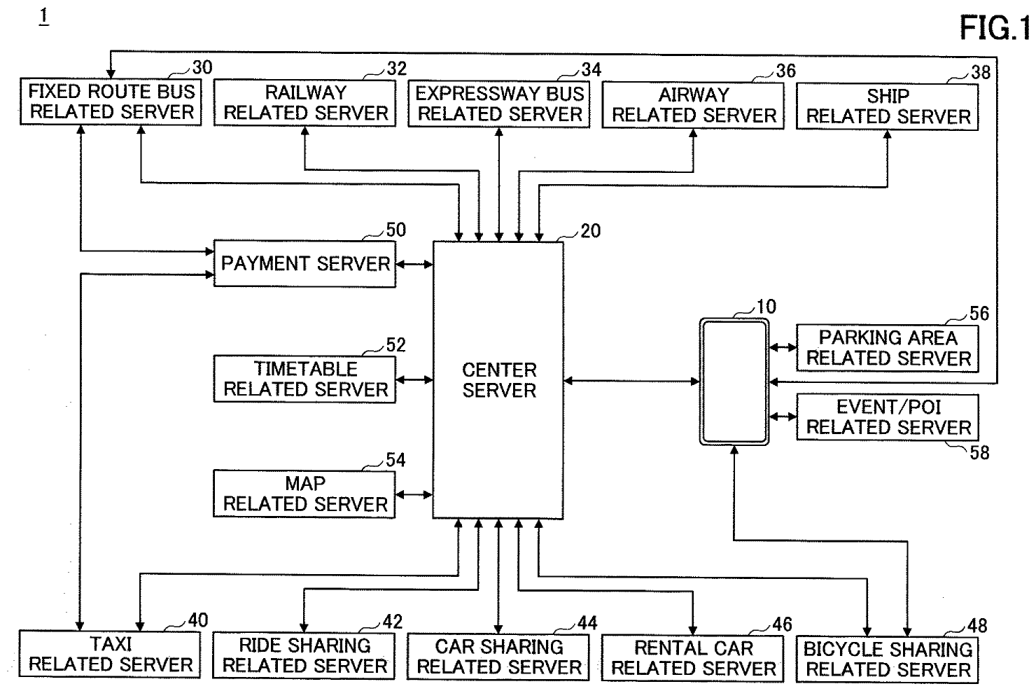

First, an overview of a multimodal route providing system 1 in an embodiment of the present invention will be described later with reference to FIG. 1.

FIG. 1 is a schematic diagram illustrating an example of a configuration of the multimodal route providing system 1 of the present embodiment.

The multimodal route providing system 1 according to the present embodiment includes a mobile terminal 10 and a center server 20.

The multimodal route providing system 1 (an example of a data generating system) performs a multimodal route search from a departure point to a destination at a center server 20 in response to a route search request including the departure point and the destination transmitted from a mobile terminal 10 to the center server in response to a user's operation. The multimodal route providing system 1 provides a route search result (hereinafter, referred to as a “multimodal route search result”) to the user through the mobile terminal 10 (specifically, a display device 16 that will be described later). A plurality of users may receive such multimodal route search results through the multimodal route providing system 1; in such a case, a plurality of mobile terminals 10 corresponding to these users may be used. At this time, the users can receive services concerning the multimodal route searches by registering the users through a route search application of the mobile terminals 10 that will be described later or a web page concerning multimodal route searches provided by the center server 20, for example. In this regard, for the thus registered users, user identification information (for example, user IDs (Identifiers)) and user authentication information (for example, passwords) corresponding to the user identification information for accessing the center server are provided on a per-user basis. Such user authentication information may be changeable by the corresponding users. Each user can use particularly the user identification information and the user authentication information to use the route search application that will be described later to receive the service concerning the multimodal route search.

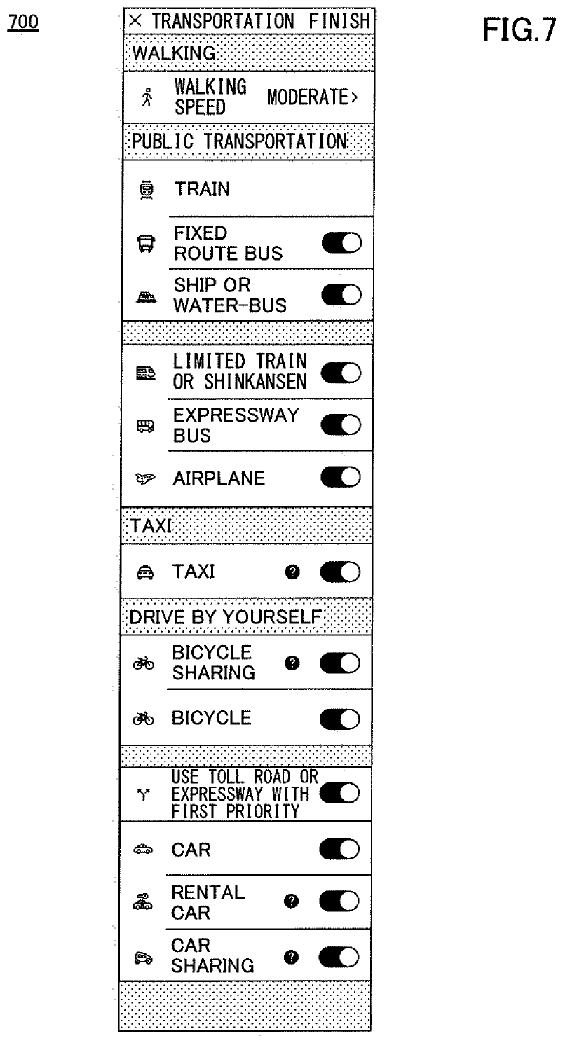

A multimodal route search is a route search from a departure point to a destination through a plurality of types of transportation, for example, and can be implemented by a known method. Through a multimodal route search, one or more route candidates that use one or more of a plurality of predetermined types of transportation are searched for. The predetermined types of transportation may include, for example, public transportation such as a fixed route bus, a railway, an expressway bus, an airplane, a ship, and so forth. The predetermined types of transportation may include some types of transportation (hereinafter referred to as “shared type transportation”) shared by unspecified persons and having a relatively small riding capacity, such as a taxi, ride sharing, car sharing, a rental car, bicycle sharing, and so forth. The predetermined types of transportation may also include some types of transportation each owned by a user himself/herself, a his/her relative, or the like, such as a private bicycle (hereinafter simply referred to as a “bicycle”), a private car (hereinafter simply referred to as a “car”), and so forth. In addition, a “ship” as a predetermined type of transportation may be any water vehicle, such as a waterbus, or the like; a waterbus or the like may be treated solely not belonging to a predetermined type of transportation “ship”. As will be described later, the predetermined types of transportation may be selectable by a user himself or herself from among a plurality of types of transportation (i.e., candidates for predetermined types of transportation) (see FIG. 7). Departure points and destinations are selected from a subject area predetermined for multimodal route searches (hereinafter referred to as a “route search subject area”). The route search subject area may be freely set; for example, an area across a plurality of countries, a whole country, an area across a plurality of prefectures or a plurality of states of a single country, a single prefecture or a single state, a single district or a single municipality, or the like may be used as the route search subject area.

As illustrated in FIG. 1, the multimodal route providing system 1 according to the present embodiment includes a fixed route bus related server 30, a railway related server 32, an expressway bus related server 34, an airway related server 36, a ship related server 38, a taxi related server 40, a ride sharing related server 42, a car sharing related server 44, a rental car related server 46, a bicycle sharing related server 48, a payment server 50, a timetable related server 52, a map related server 54, a parking area related server 56, and an event/POI (Point of Interest) related server 58.

The mobile terminal 10 is a user terminal for receiving one or more route candidates corresponding to a multimodal route search result. The mobile terminal 10 may be, for example, a cellular phone, a smartphone, a tablet terminal, a laptop computer, a mobile (portable) navigation device, or the like.

The mobile terminal 10 is communicatively connected to the center server 20 through a predetermined communication network (hereinafter, simply referred to as a “communication network”) such as a mobile communication network using base stations, a satellite communication network using a communication satellite, the Internet, or the like and transmits a route search request to the center server 20 in response to operation performed by a user. The mobile terminal 10 provides a user with a multimodal route search result delivered from the center server 20 by displaying the multimodal route search result on the display device 16.

The mobile terminal 10 is an example of a user terminal for the user to receive a multimodal route search result; the multimodal route providing system 1 may include another user terminal (for example, a desktop-type computer, a navigation device fixed to a vehicle, or the like) instead of or in addition to the mobile terminal 10.

The mobile terminal 10 is connected to communicate with the fixed route bus related server 30, the bicycle sharing related server 48, the parking area related server 56, the event and POI related server 58, and so forth.

The fixed route bus related server 30, for example, is operated by operating companies or affiliated companies of fixed route buses as a predetermined type of transportation, and manages information concerning operations of fixed route buses (for example, operation states such as timetables, delays, or the like; the present location of each bus; and so forth).

The bicycle sharing related server 48, for example, is operated by service providers of bicycle sharing or affiliated companies as a predetermined type of transportation, and manages various information concerning services of bicycle sharing (for example, the number of bicycles that can be provided, the current number of bicycles available, and so forth for each of a plurality of cycle ports that provide shared bicycles, and so forth).

The parking area related server 56 manages facility information of each of a plurality of previously registered parking areas (for example, the addresses, the numbers of car parking spaces, and so forth) and information on usage situations (for example, the number of vacant car parking spaces for each of the parking areas, and so forth).

The event and POI related server 58 manages, in the latest states, information concerning events held in the route search subject area (hereinafter referred to as “event information”) and information concerning POI (for example, facilities, shops, and so forth) within a predetermined area (hereinafter referred to as “POI information”).

Thus, the mobile terminal 10 can obtain various information such as information concerning fixed route buses and bicycle sharing as predetermined types of transportation; information concerning car sharing, rental cars, and parking areas for using cars as predetermined types of transportation; information concerning events that may motivate users to move, information concerning POI, and so forth.

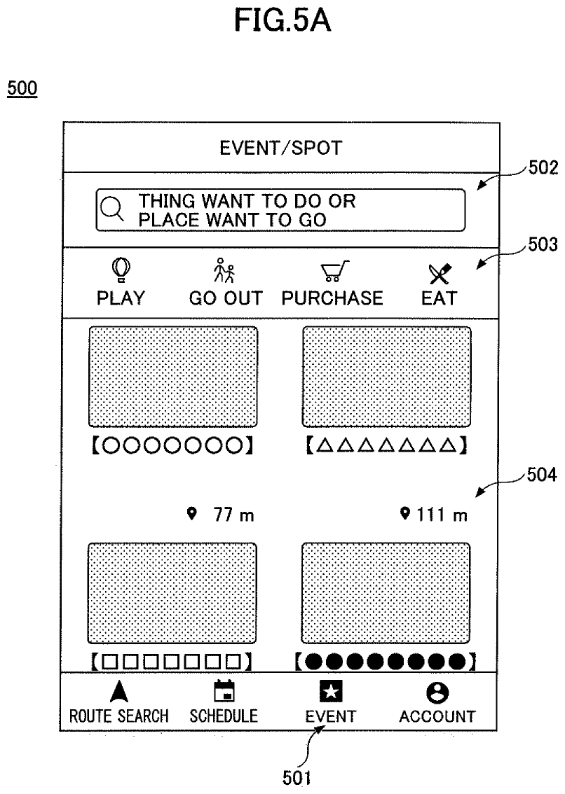

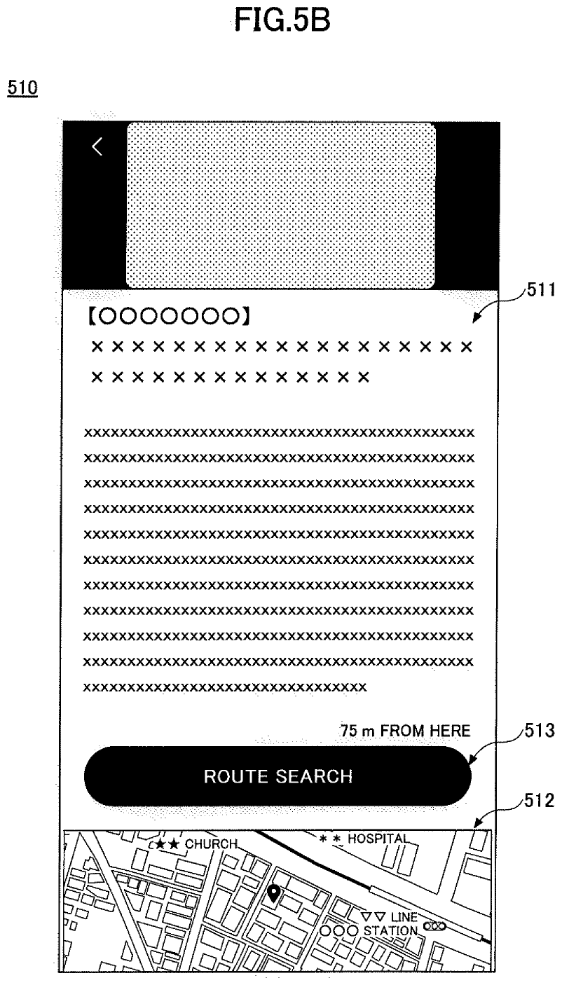

Details of communication of the mobile terminal 10 with the fixed route bus related server 30, the bicycle sharing related server 48, the parking area related server 56, the event and POI related server 58, and so forth will be described later (with reference to FIGS. 5A-6C, 11A-13B, and so forth).

The mobile terminal 10 may be communicatively connected to the railway related server 32, the expressway bus related server 34, the airway related server 36, the ship related server 38, the taxi related server 40, the ride sharing related server 42, the car sharing related server 44, the rental car related server 46, and so forth and may obtain various information therefrom. For example, the mobile terminal 10 may obtain various information from these servers via web pages operated by these servers.

The center server 20 (an example of a data generating apparatus) is communicatively connected to the mobile terminal 10 through a communication network, performs a multimodal route search in response to a route search request from the mobile terminal 10, and transmits (delivers) a multimodal route search result to the mobile terminal 10.

The center server 20 is communicatively connected with the fixed route bus related server 30, the railway related server 32, the expressway bus related server 34, the airway related server 36, the ship related server 38, the taxi related server 40, the ride sharing related server 42, the car sharing related server 44, the rental car related server 46, the bicycle sharing related server 48, and so forth through the communication network.

The railway related server 32, for example, is operated by operating companies or affiliated companies of railways as a predetermined type of transportation and manages information concerning railway operations and so forth (for example, timetables, operation states including delays, and so forth, seat availability of each reservable train, and so forth).

The expressway bus related server 34 manages information concerning operations of expressway buses as a predetermined type of transportation (for example, timetables, operation states including delays, and so forth, seat availability of each bus, and so forth).

The airway related server 36 is operated by operating companies or affiliated companies of airplanes as a predetermined type of transportation, and manages information concerning operations of airplanes (for example, timetables, operation states including delays, and so forth, seat availability of each flight, and so forth).

The ship related server 38 is operated by operating companies or affiliated companies of ships as a predetermined type of transportation and manages information concerning operations of ships (for example, timetables, operation states including delays, and so forth, seat availability of each reservable ship, and so forth).

The taxi related server 40, for example, is operated by providers or affiliated companies of taxi services as a predetermined type of transportation and manages various information concerning taxi services (for example, operation states including location information, empty/in-service states, and so forth of each taxi, and so forth).

The ride sharing related server 42, for example, is operated by service providers or affiliated companies of ride sharing as a predetermined type of transportation and manages various information concerning ride sharing services (for example, the present location, whether dispatching is possible, and so forth for each vehicle operated in ride sharing).

The car sharing related server 44, for example, is operated by service providers or affiliated companies of car sharing as a predetermined type of transportation and manages various information concerning car sharing services (for example, the number of parking spaces, the number of currently available cars, the number of returnable cars, and so forth of each station providing sharable cars).

The rental car related server 46 is operated by, for example, service providers or affiliated companies of rental cars as a predetermined type of transportation and manages various information concerning rental car services (for example, the types of vehicles that can be prepared at each office, the number of vehicles that can be currently prepared for each vehicle type at each office, and so forth).

Thus, the above-described servers 30-48 correspond to respective predetermined types of transportation for multimodal route searches; the center server 20 therefore can obtain various information concerning predetermined types of transportation for multimodal route searches from the servers 30-48.

Timetable information of several types of transportation (for example, fixed route buses, railways, expressway buses, airplanes, ships, and so forth) for which operation schedules including operation routes and operation times are previously determined may be obtained from the timetable related server 52 as will be described later.

Each of the predetermined types of transportation may be provided by a plurality of companies. Therefore, each of the fixed route bus related server 30, the railway related server 32, the expressway bus related server 34, the airway related server 36, the ship related server 38, the taxi related server 40, the ride sharing related server 42, the car sharing related server 44, the rental car related server 46, and the bicycle sharing related server 48 may be provided on a per-company basis of companies that provide services of corresponding types of transportation.

In this regard, a single company or a single group of companies may provide more than one of the predetermined types of transportation. Therefore, a single server corresponding to a single company or a single group of companies functions as some of the fixed route bus related server 30, the railway related server 32, the expressway bus related server 34, the airway related server 36, the ship related server 38, the taxi related server 40, the ride sharing related server 42, the car sharing related server 44, the rental car related server 46, and the bicycle sharing related server 48.

The center server 20 is communicatively connected to the payment server 50 through a communication network. For example, the payment server 50 is operated by a payment agent company or the like and performs payment processes for usages of predetermined types of transportation by users. For example, the payment server 50 performs payment processes with credit card companies corresponding to credit cards previously registered by users with the center server 20 (hereinafter referred to as “registered credit cards”).

For example, in response to a request from the center server 20, the payment server 50 temporarily secures a credit amount of a credit card for a temporary fare in response to a taxi reservation of a user as will be described later. The payment server 50 then re-secures a credit amount of the credit card for a fixed fare and records the corresponding sales amount in response to a request from the center server 20 that has received a fare confirmation notification from the taxi related server 40.

For example, in response to a request from the center server 20, the payment server 50 secures a credit amount of a credit card in response to a request from a user to purchase a fixed route bus ticket, which will be described later, and records the corresponding sales amount.

Thus, the center server 20 can cause the payment server 50 to perform, in an integrated manner, various payment processes concerning usages of predetermined types of transportation by users.

The center server 20 is also communicatively connected to the timetable related server 52 and the map related server 54. The timetable related server 52 manages information concerning timetables of predetermined types of transportation for which operation schedules including operation routes and operation times are previously determined. The map related server 54 manages map information including road information in the route search subject area. Thus, the center server 20 can obtain information concerning timetables and map information necessary for multimodal route searches from the timetable related server 52 and the map related server 54 and update old information concerning timetables, map information, and so forth.

### [Configuration of Multimodal Route Providing System]

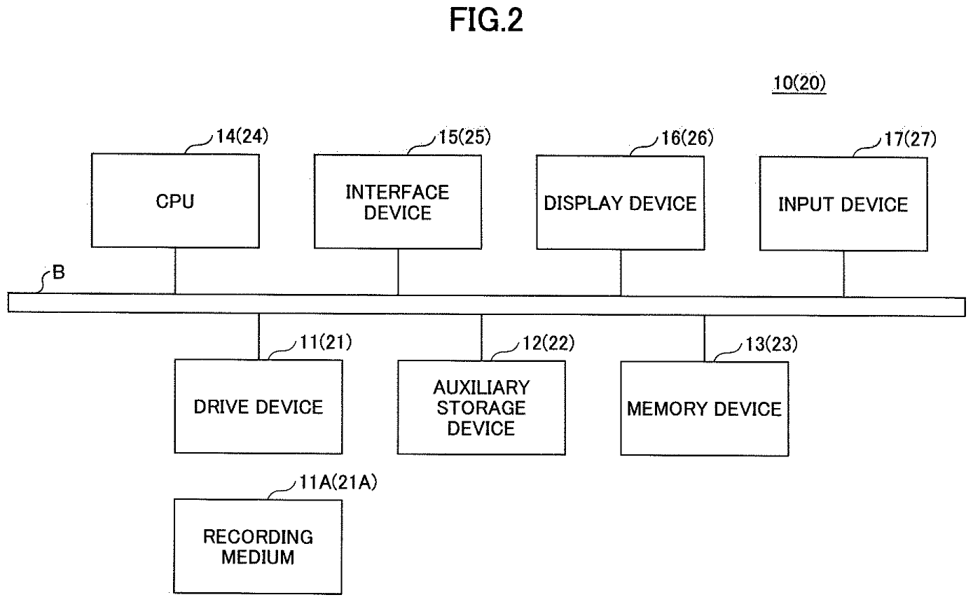

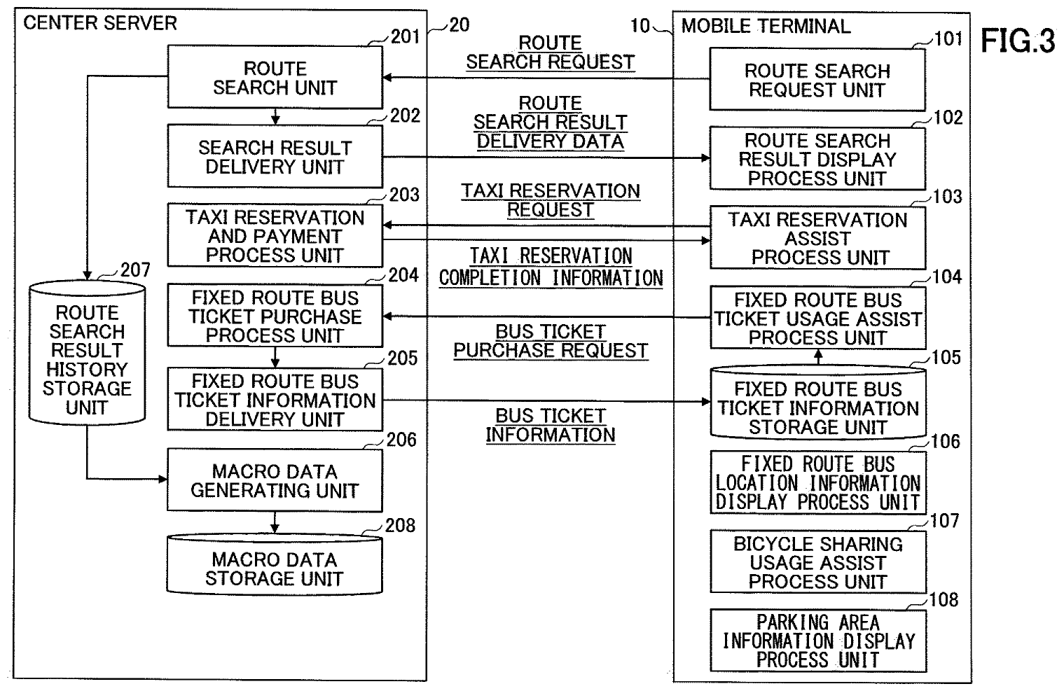

Next, a configuration of the multimodal route providing system 1 will be described later in detail with reference to FIGS. 2 and 3 in addition to FIG. 1.

FIG. 2 illustrates an example of a hardware configuration of the mobile terminal 10. FIG. 3 is a functional block diagram illustrating an example of a functional configuration of the multimodal route providing system 1.

Because the hardware configuration of the center server 20 is almost the same as the hardware configuration of the mobile terminal 10, the description will now be made for the center server 20 as well as the mobile terminal 10 with reference to FIG. 2. In this regard, in the description of the center server 20 with reference to FIG. 2, the reference numerals “21”, “21A”, “22”, “23”, “24”, “25”, “26”, and “27” enclosed in brackets will be used.

### <Composition of Mobile Terminal>

As illustrated in FIG. 2, the mobile terminal includes a drive device 11, an auxiliary storage device 12, a memory device 13, a CPU (Central Processing unit) 14, an interface device 15, a display device 16, and an input device 17, each of which is connected by a bus B.

A program that implements various functions of the mobile terminal 10 is provided, for example, from a recording medium 11A. The recording medium 11A is, for example, a portable recording medium such as a CD-ROM (Compact Disc Read-Only Memory), a DVD-ROM (Digital Versatile Disc Read-Only Memory), a USB (Universal Serial Bus) memory, or an SD memory card. Both the recording medium 11A and the auxiliary storage device 12 correspond to computer-readable recording media. In response to the recording medium 11A on which the program is recorded being set in the drive device 11, the program is installed in the auxiliary storage device 12 from the recording medium 11A via the drive device 11. It is also possible that the program is downloaded from another computer (for example, the center server 20) via a communication network and installed in the auxiliary storage device 12.

The auxiliary storage device 12 stores the installed program and stores necessary files and data. The auxiliary storage device 12 may be, for example, a HDD (hard disk drive), a flash memory, or the like.

The memory device 13 reads out and stores the program from the auxiliary storage device 12 in response to an instruction to activate the program.

The CPU 14 executes the program stored in the memory device 13 and performs the various functions of the mobile terminal 10 according to the program.

The interface device 15 is used, for example, as an interface for connecting to a communication network.

The display device 16 displays a GUI (Graphical User Interface) such as an application screen page of the route search application, which will be described later, according to the program executed by the CPU 14. The display device 16 may be, for example, a liquid crystal display or an organic EL (Electro Luminescence) display.

The input device 17 may include, for example, a keyboard, a mouse, a touch panel, buttons, or the like, and may be used by the user to input various operating instructions to the mobile terminal 10.

As illustrated in FIG. 3, the mobile terminal includes a route search request unit 101, a route search result display process unit 102, a taxi reservation assist process unit 103, a fixed route bus ticket usage assist process unit 104, a fixed route bus location information display process unit 106, a bicycle sharing usage assist process unit 107, and a parking area information display process unit 108 as functional units that are implemented as a result of the CPU 14 executing one or more programs installed in the auxiliary storage device 12, for example, the application for receiving multimodal route search results (i.e., the “route search application”). The mobile terminal 10 uses a fixed route bus ticket information storage unit 105 or the like. The fixed route bus ticket information storage unit 105 may be implemented by using, for example, the auxiliary storage device 12.

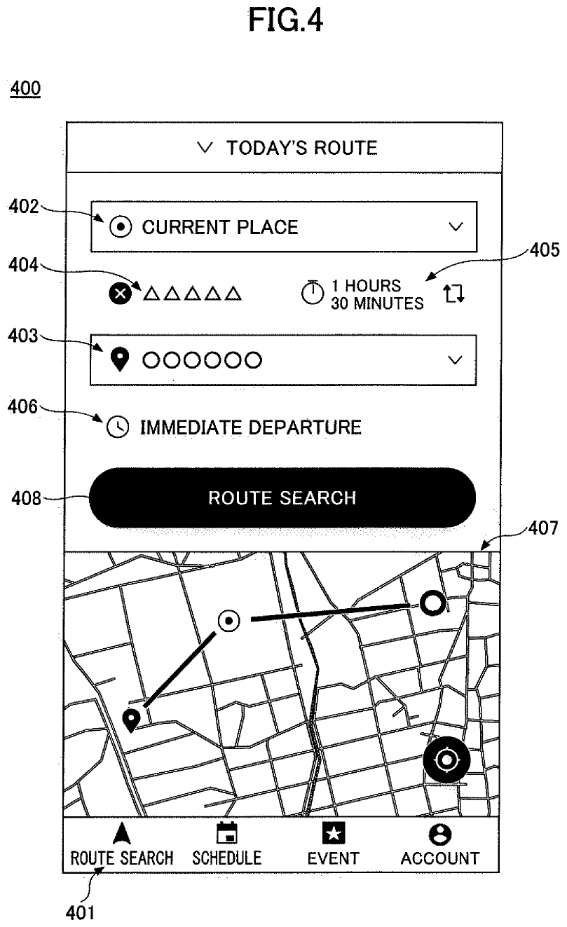

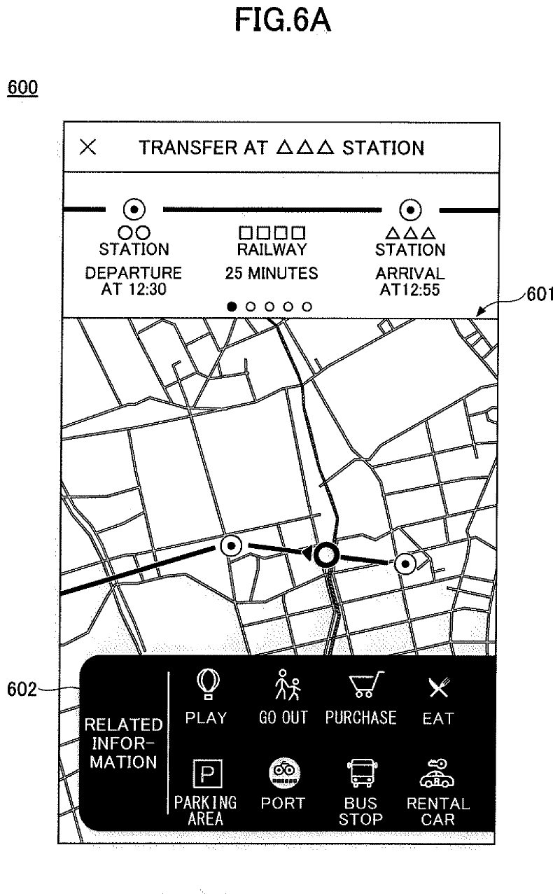

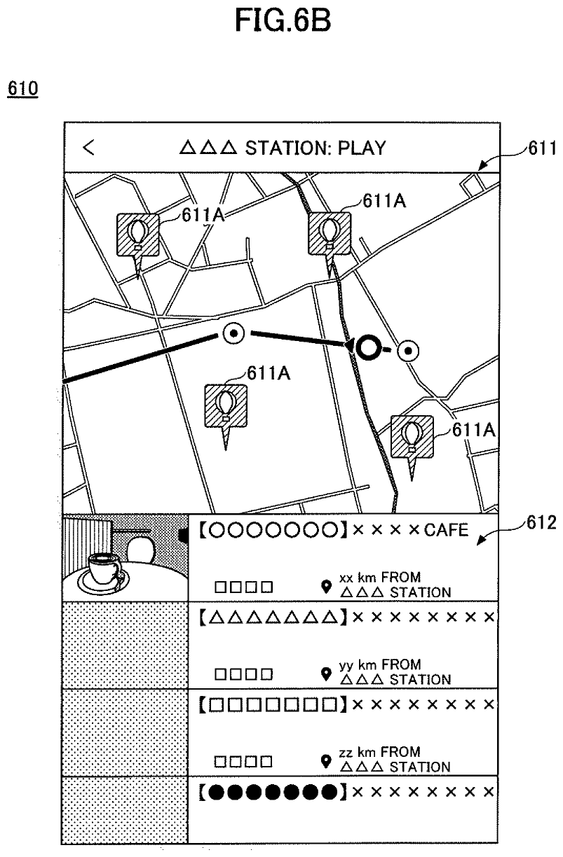

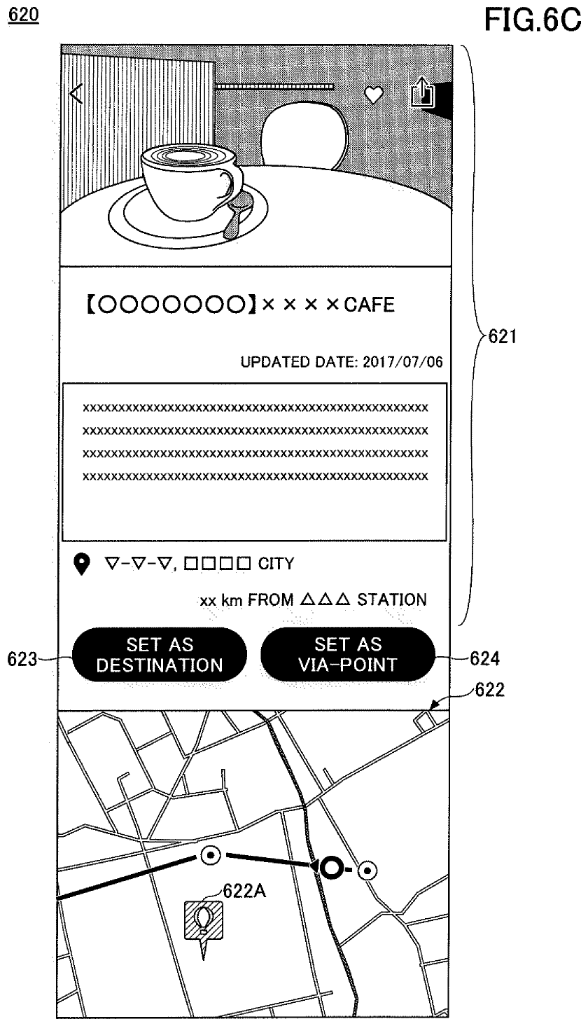

The route search request unit 101 displays an application screen page concerning a route search of the route search application and transmits a route search request including user identification information, user authentication information, information of a departure point and a destination, information of a departure time, and so forth to the center server 20 in response to operations of the user performed onto the application screen page. The route search request may include information of a via-point that will be described later (with reference to FIGS. 4 and 6A-6C). An application screen page for a user to request a multimodal route search, i.e., for transmitting a route search request from the mobile terminal 10 to the center server 20 and a corresponding operation method will be described later (with reference to FIGS. 4-7).

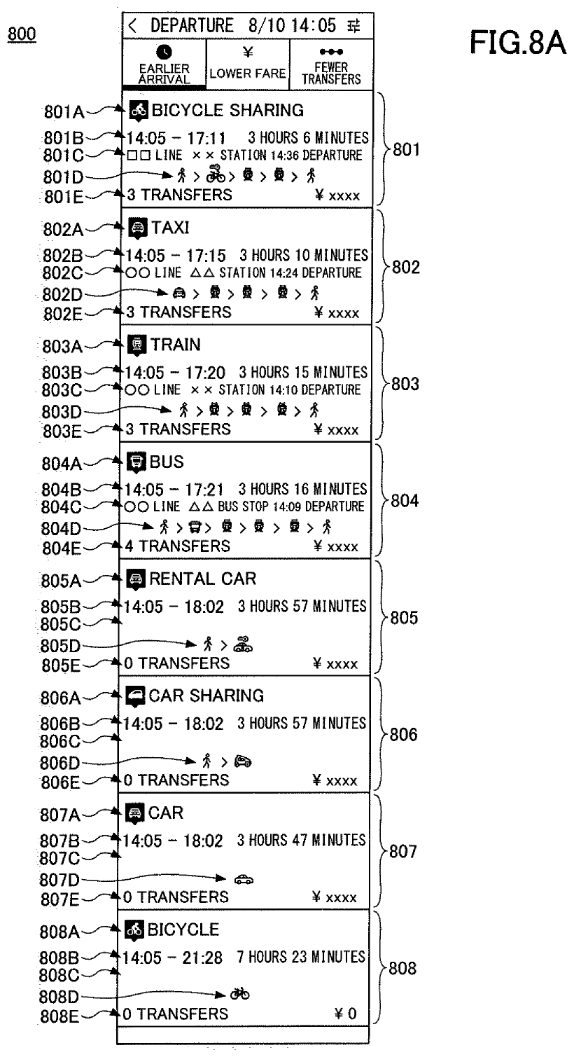

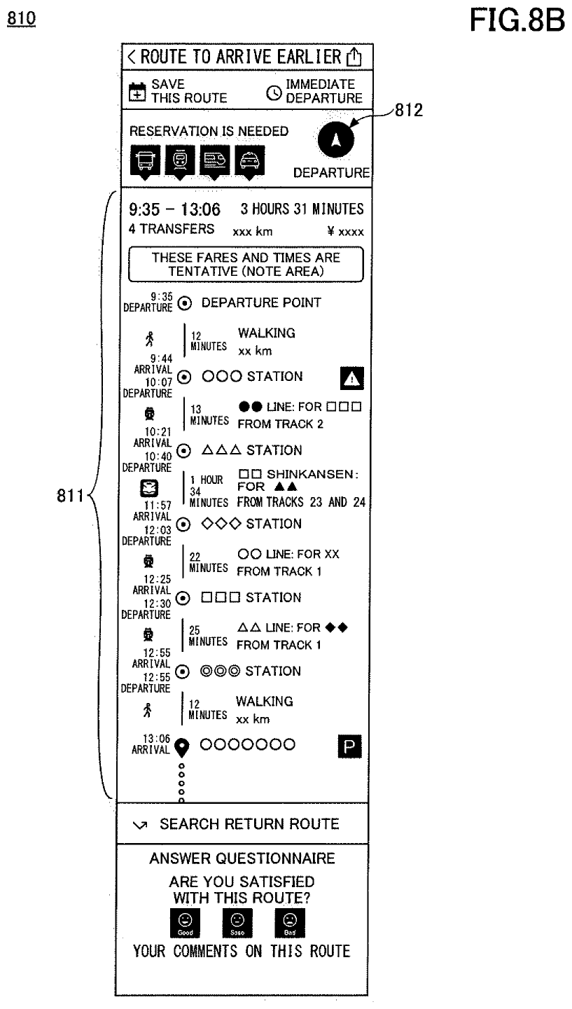

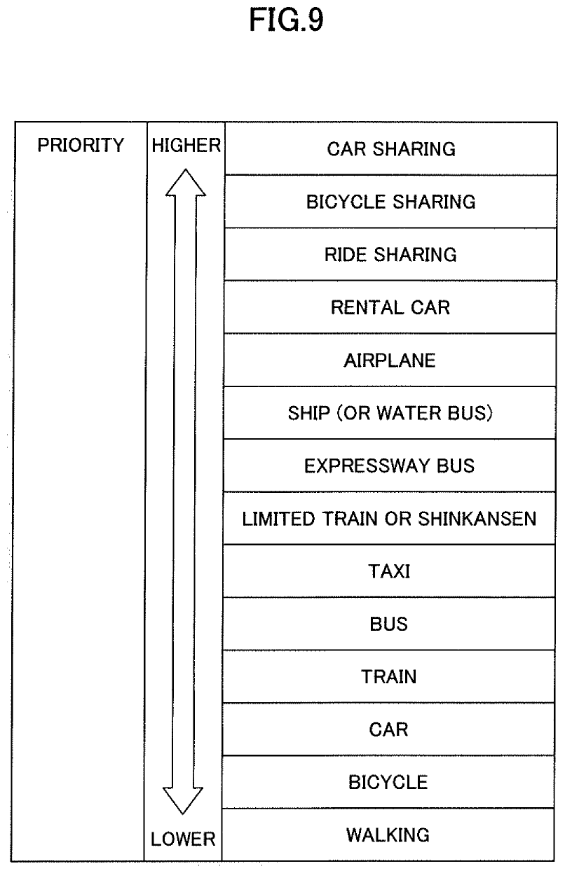

The route search result display process unit 102 displays a multimodal route search result on the display device 16 on the basis of delivery data of the multimodal route search result sent back (delivered) from the center server 20 (hereinafter referred to as “route search result delivery data”). Details of the multimodal route search result displayed on the display device 16 will be described later (see FIGS. 8A-9).

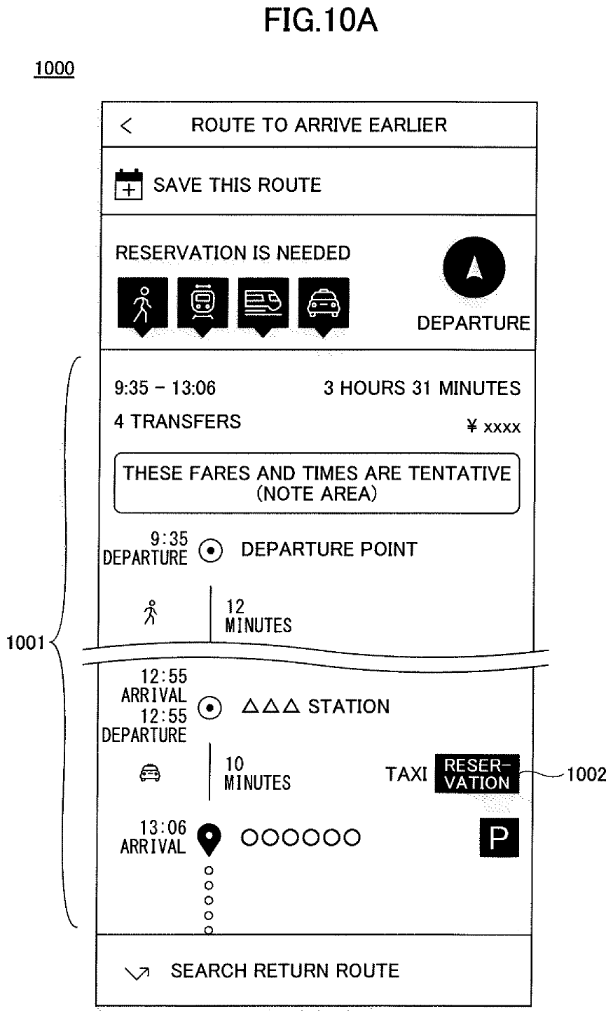

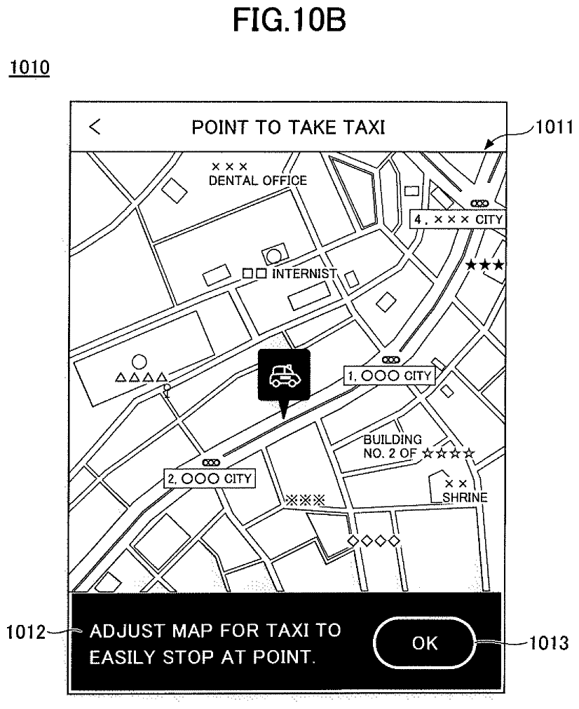

The taxi reservation assist process unit 103 executes a process to assist a user of a taxi as a predetermined type of transportation to perform a taxi dispatching reservation in response to a predetermined operation performed by the user onto a predetermined application screen page of the route search application. In more detail, the taxi reservation assist process unit (103) transmits a taxi reservation request including information on a desired taxi dispatching location and information on a desired taxi dispatching time to the center server (20) in response to predetermined operations of the user performed onto the predetermined application screen page of the route search application. The taxi reservation assist process unit 103 may indicate the completion of the taxi dispatching reservation on the basis of information indicating the completion of the reservation received from the center server 20 and display the contents of the taxi dispatching reservation on the application screen page. The application screen page with which a user reserves dispatching of a taxi and how to operate the application screen page will be further described later (see FIG. 10).

The mobile terminal 10 may also be used to implement, instead of or in addition to a taxi reservation, a ride-sharing vehicle dispatching request in response to a user's operation.

The fixed route bus ticket usage assist process unit 104 assists a user to purchase and use a predetermined ticket for a fixed route bus as a predetermined type of transportation in response to the user's predetermined operation performed onto a predetermined application screen page of the route search application. The predetermined ticket is, for example, a “one-day free pass” or the like allowing a user to get on and get off fixed route buses within a predetermined period (hereinafter referred to as a “time-limited ticket”). A time-limited ticket may be such a time-limited ticket (hereinafter referred to as a “specified time-limited ticket”) as a “6-hour pass”, for which the validity may expire at a time during a service period of fixed route buses in a day. A time-limited ticket may be a ticket for which further a valid geographical area is limited, for example, “a ticket limited to ◯◯ city”, “a ticket limited to XX route”, or the like. A predetermined ticket mentioned above may be a ticket (hereinafter referred to as a “section ticket”) for which a valid section is limited as “from ◯◯ bus stop to XX bus stop”, or the like.

In more detail, the fixed route bus ticket usage assist process unit 104 transmits a purchase request (hereinafter, referred to as a “bus ticket purchase request”) for a predetermined ticket of a fixed route bus to the center server 20 in response to a predetermined operation of a user onto a predetermined application screen page of the route search application. The fixed route bus ticket usage assist process unit 104 displays, on the display device 16, fixed route bus ticket information received (delivered) from the center server 20 and stored in the fixed route bus ticket information storage unit 105. The fixed route bus ticket information corresponds to the predetermined ticket of a fixed route bus that has been purchased; thus, the user can use a fixed route bus by showing the fixed route bus ticket information displayed on the display device 16 to the driver, conductor, or the like of the fixed route bus.

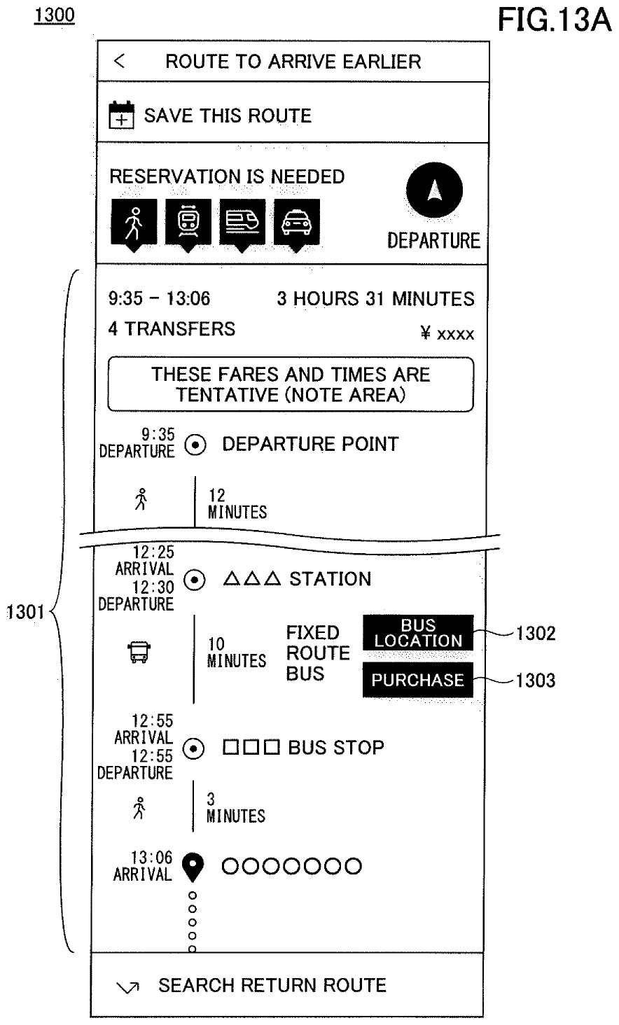

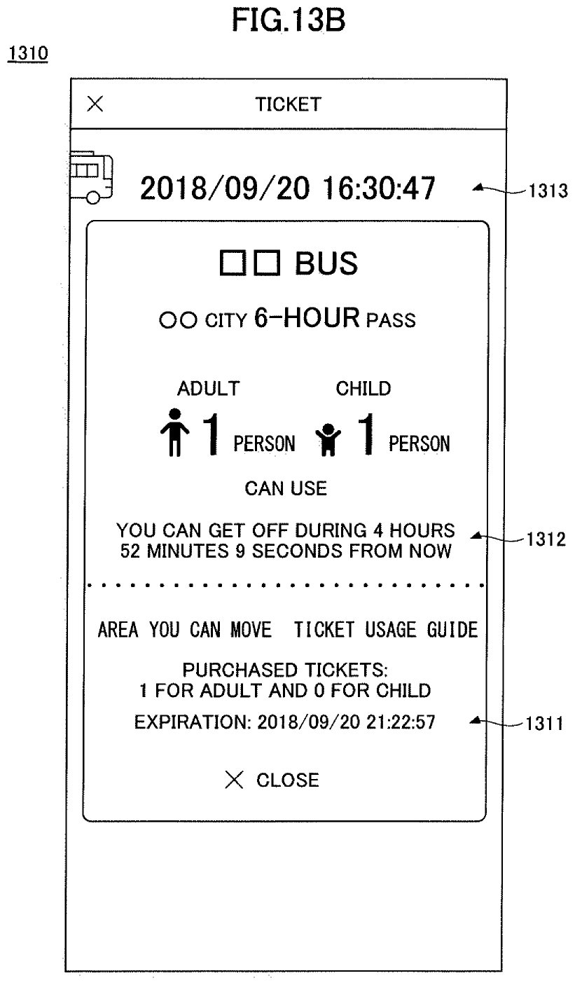

The application screen pages for users to purchase predetermined tickets of fixed route buses, the operation methods therefor, and specific examples of fixed route bus ticket information will be described later (with reference to FIGS. 13A and 13B).

The fixed route bus ticket usage assist process unit 104 may directly transmit a bus ticket purchase request to the fixed route bus related server 30 without using the center server 20. In this case, the mobile terminal 10 may obtain fixed route bus ticket information directly from the fixed route bus related server 30.

The mobile terminal 10 may further assist a user to purchase and use, instead of or in addition to a fixed route bus ticket, a ticket for another predetermined type of transportation, i.e., in particular, a public transportation ticket (for example, a railway ticket, an expressway bus ticket, an airway ticket, a ship ticket, or the like) for which an operation schedule including an operation route and an operation time is previously determined, in the same manner as in the case of purchasing and using a fixed route bus ticket.

As described above, the fixed route bus ticket information storage unit 105 stores fixed route bus ticket information delivered from the center server 20.

The fixed route bus location information display process unit 106 displays, on the display device 16, location information of fixed route buses as a predetermined type of transportation, specifically, each fixed route bus. In more detail, the fixed route bus location information display process unit 106 may obtain information (hereinafter, referred to as “present location information”) concerning the real-time present location of each fixed route bus from the fixed route bus related server 30 and display the information on the display device 16 in response to a predetermined operation of a user onto a predetermined application screen page of the route search application.

In addition to the present location information of each fixed route bus, the fixed route bus location information display process unit 106 may obtain from the fixed route bus related server 30 information on the scheduled location of each fixed route bus according to the corresponding operation schedule (hereinafter, referred to as “scheduled location information”), that is, information on the location of each fixed route bus assuming that the fixed route bus is operated according to the timetable, and display the information on the display device 16.

At this time, the fixed route bus location information display process unit 106 may obtain the present location information and the scheduled location information of each fixed route bus through a predetermined Web API (Application Programming Interface) that is provided, for example, by the fixed route bus related server 30.

Thus, a user can determine whether to select a route candidate using a fixed route bus from among a plurality of route candidates of a multimodal route search result while, for example, knowing the present location of the fixed route bus and the difference (that is, a delayed condition) between the present location and the scheduled location of the fixed route bus.

The application screen page for displaying location information of a fixed route bus on the display device 16 and the operation method therefor will be described later (with reference to FIGS. 13A and 13B).

The fixed route bus location information display process unit 106 may obtain the location information of each fixed route bus through the center server 20. The mobile terminal 10 may also display on the display device 16, instead of or in addition to the location information of each fixed route bus, the location information of another predetermined type of transportation, particularly the location information of public transportation (for example, the location information of each train of railway, the location information of each expressway bus, or the like) for which the operation schedule including the operation route and operation time of operation is previously determined.

The bicycle sharing usage assist process unit 107 assists a user to use bicycle sharing as a predetermined type of transportation. For example, the bicycle sharing usage assist process unit 107 activates an application (for example, an application delivered by a provider of a bicycle sharing service) for using bicycle sharing in response to a predetermined operation of a user onto a predetermined application screen page of the route search application, and changes the display contents on the display device 16 to an application screen page of the application for using bicycle sharing.

The bicycle sharing usage assist process unit 107 may activate a browser to cause the browser to access a bicycle sharing web page. Thus, for example, for selecting a route candidate using bicycle sharing from among a plurality of route candidates of a multimodal route search result, a user can know the number of currently available bicycles at a corresponding cycle port of bicycle sharing, make a reservation for actually using a bicycle, and so forth.

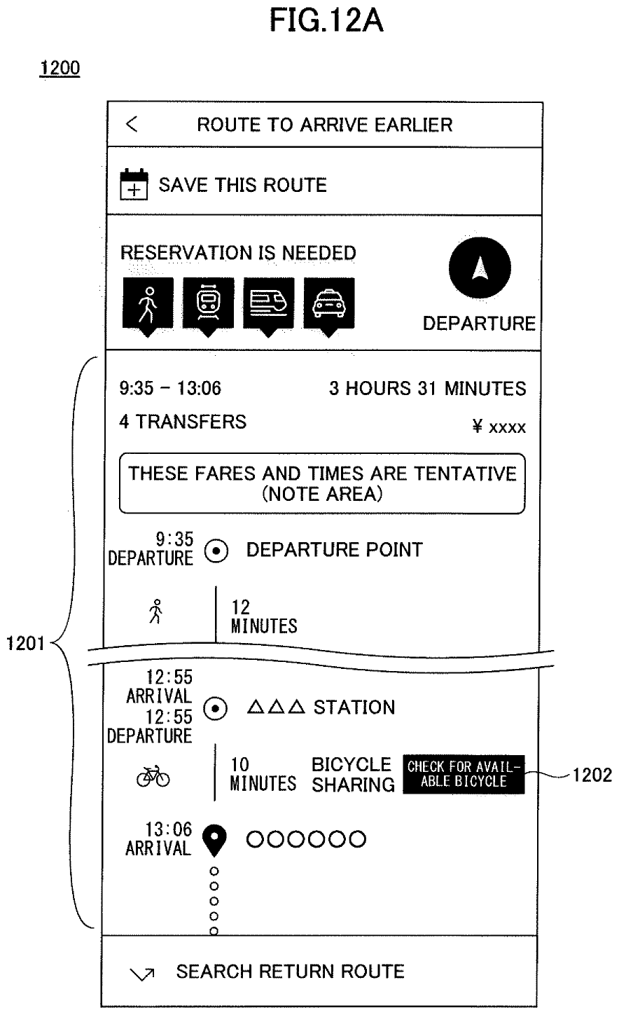

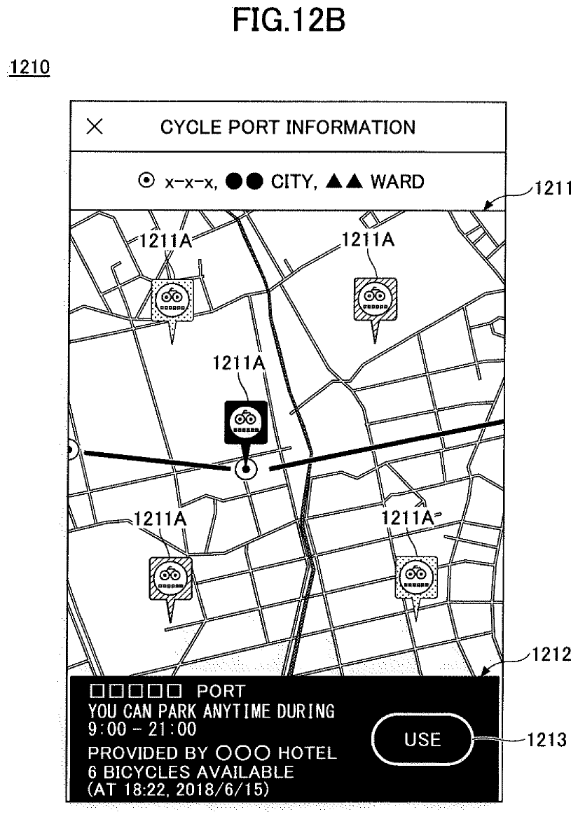

The application screen pages for a user to use bicycle sharing and the operation method therefor will be described later (with reference to FIGS. 12A and 12B).

Note that the mobile terminal 10 may assist a user to use car sharing, instead of or in addition to assisting a user to use bicycle sharing, in a manner similar to that described above.

The parking area information display process unit 108 displays information of a plurality of parking areas (hereinafter referred to as “parking area information”), managed by the parking area related server 56, on the display device 16. Parking area information may include facility information for each parking area (for example, the name, the address, the parking fee, the number of car parking spaces, and so forth) as well as information on the number of vacant car parking spaces.

For example, the parking area information display process unit 108 obtains parking area information from the parking area related server 56 in response to a predetermined operation of a user onto a predetermined application screen page of the route search application and displays the information on the display device 16. At this time, the parking area information display process unit 108 may, for example, obtain the parking area information through a predetermined Web API provided by the parking area related server 56.

Thus, for example, for selecting a route candidate using a private car or a rental car requiring a parking area from among a plurality of route candidates of a multimodal route search result, a user can know a vacant car parking space state of a parking area.

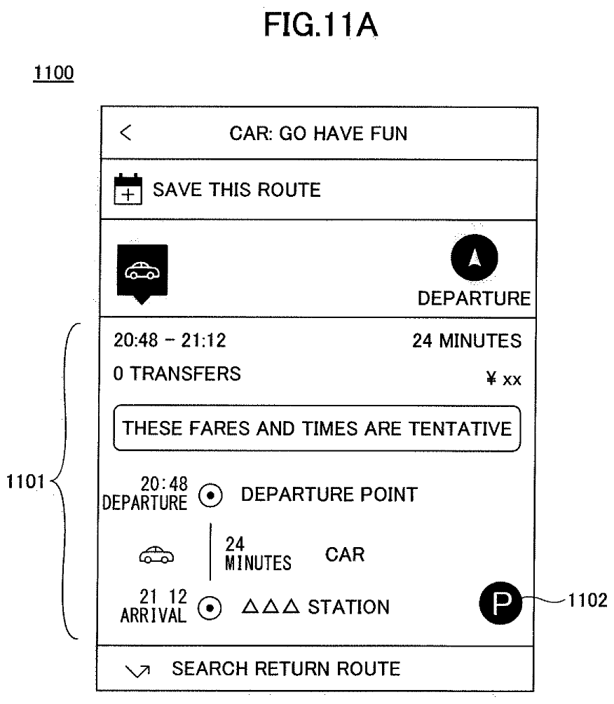

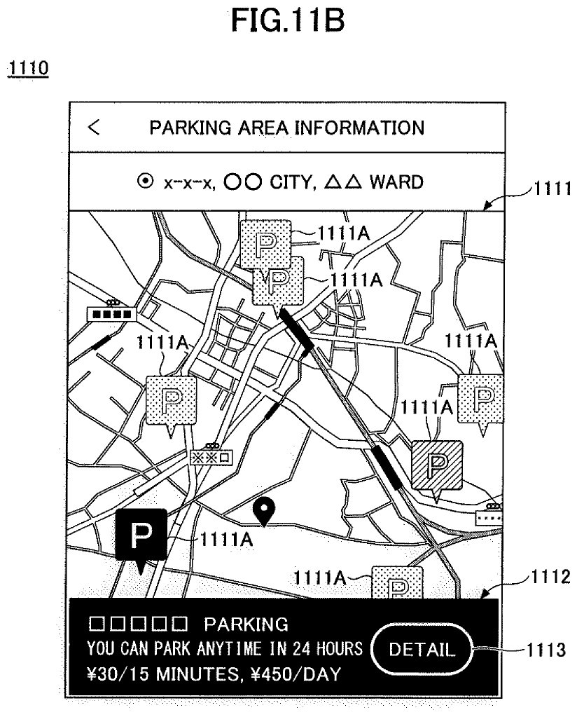

The application screen page for a user to read parking area information and the operation method thereof will be described later (with reference to FIGS. 11A and 11B).

The parking area information display process unit 108 may obtain parking area information through the center server 20. In this case, the parking area related server 56 is communicatively connected to the center server 20.

### <Configuration of Center Server>

As illustrated in FIG. 2, the center server 20 includes a drive device 21, an auxiliary storage device 22, a memory device 23, a CPU 24, an interface device 25, a display device 26, and an input device 27, each of which is connected by a bus B. The hardware configuration of the center server 20 will now be described mainly for the differences from the drive device 11, the auxiliary storage device 12, the memory device 13, the CPU 14, the interface device 15, the display device 16, the input device 17, and so forth of the mobile terminal 10.

Programs for implementing various functions of the center server 20 are provided, for example, from a recording medium 21A. In response to the recording medium 21A on which the programs are recorded being set in the drive device 21, the programs are installed in the auxiliary storage device 22 from the recording medium 21A through the drive device 21. The programs may be also downloaded from another computer via a communication network and installed in the auxiliary storage device 22.

The auxiliary storage device 22 stores the various programs installed and stores necessary files and data.

In response to an instruction to activate the programs being input, the memory device 23 reads out the programs from the auxiliary storage device 22 and stores them.

The CPU 24 executes the programs stored in the memory device 23 and performs the various functions of the center server 20 according to the programs.

The interface device 25 is used as an interface for, for example, connecting to a communication network.

The display device 26 displays, for example, a GUI according to a program executed by the CPU 24.

The input device 27 is used by an operator or an administrator of the center server 20 to input various operating instructions to the center server 20.

As illustrated in FIG. 3, the center server 20 includes a route search unit 201, a search result delivery unit 202, a taxi reservation and payment process unit 203, a fixed route bus ticket purchase process unit 204, a fixed route bus ticket information delivery unit 205, and a macro data generating unit 206 as functional units implemented as a result of the CPU 24 executing one or more programs installed in the auxiliary storage device 22. The center server 20 uses a route search result history storage unit 207 and a macro data storage unit 208. The route search result history storage unit 207 and the macro data storage unit 208 can be implemented by using, for example, the auxiliary storage device 22 or an external storage device that is communicatively connected with the center server 20.

The route search unit 201 performs a multimodal route search, which uses one or more of a plurality of predetermined types of transportation, from a departure point to a destination included in a route search request, in response to the route search request received from the mobile terminal 10. The route search unit 201 outputs one or more route candidates each using one or more of the plurality of predetermined types of transportation. The plurality of route candidates output by the route search unit 201 may include two or more route candidates using mutually different predetermined types of transportation or using mutually different combinations of predetermined types of transportation. Details of multimodal route searches by the route search unit 201 and so forth will be described later.

The functions of the route search unit 201 may be implemented by the mobile terminal 10. In such a case, for example, the mobile terminal 10 may obtain resource information necessary for multimodal route searches from the center server 20.

The mobile terminal 10 is communicatively connected with the fixed route bus related server 30, the railway related server 32, the expressway bus related server 34, the airway related server 36, the ship related server 38, the taxi related server 40, the ride sharing related server 42, the car sharing related server 44, the rental car related server 46, the bicycle sharing related server 48, the timetable related server 52, the map related server 54, and so forth, and may obtain resource information necessary for multimodal route searches from these servers.

The search result delivery unit 202 generates delivery data (hereinafter, referred to as “route search result delivery data”) for displaying a multimodal route search result on the display device 16 of the mobile terminal 10 on the basis of a multimodal route search result including one or more route candidates output by the route search unit 201 and delivers the data to the mobile terminal 10. In other words, the search result delivery unit 202 transmits delivery data including display details according to which a multimodal route search result is displayed on the display device 16 of the mobile terminal 10 to the mobile terminal 10 and displays the multimodal route search result of the route search unit 201 on the display device 16 of the mobile terminal 10.

The display details for displaying a multimodal route search result on the display device 16 of the mobile terminal 10 may be controlled by the mobile terminal 10, for example, by the route search result display process unit 102. In this case, route search result delivery data delivered from the search result delivery unit 202 to the mobile terminal 10 does not include information on the display details. For a case where, as described above, the functions of the route search unit 201 are implemented by the mobile terminal 10, the display details for displaying a multimodal route search result on the display device 16 of the mobile terminal 10 are controlled by the mobile terminal 10 accordingly.

The taxi reservation and payment process unit 203 performs a taxi reservation process in response to a taxi reservation request received from the mobile terminal and a payment process for a user to use a taxi corresponding to the taxi reservation. In more detail, the taxi reservation and payment process unit 203 requests the taxi related server 40 to make a taxi reservation (a taxi dispatching reservation) on the basis of the contents concerning a taxi dispatching request included in a taxi reservation request (for example, the location where the vehicle is to be dispatched, i.e., the desired taxi dispatching location, the time when the vehicle is to be dispatched, i.e., the desired taxi dispatching time, and so forth). The taxi reservation and payment process unit 203 requests the payment server 50 to implement a payment for a taxi usage on the basis of the final used amount indicated from the taxi related server 40 after a taxi is used on the basis of the taxi reservation.

The fixed route bus ticket purchase process unit 204 performs a purchase process for a predetermined ticket of a fixed route bus through the payment server 50 on the basis of previously registered credit card information of a user according to a purchase request for the fixed route bus ticket received from the mobile terminal 10.

The fixed route bus ticket purchase process unit 204 may perform a purchase process for a predetermined ticket of a fixed route bus by transferring a user's fixed route bus ticket purchase request to the fixed route bus related server 30. In this case, a payment process for a purchase of a predetermined ticket of a fixed route bus is performed through the fixed route bus related server 30 and so forth.

The fixed route bus ticket information delivery unit 205 generates fixed route bus ticket information corresponding to a ticket after the completion of a purchase process for the fixed route bus ticket by the fixed route bus ticket purchase process unit 204 and delivers (transmits) the information to the mobile terminal 10.

As described above, the fixed route bus ticket information delivery unit 205 may obtain fixed route bus ticket information generated by the fixed route bus related server 30 and deliver the obtained fixed route bus ticket information to the mobile terminal 10.

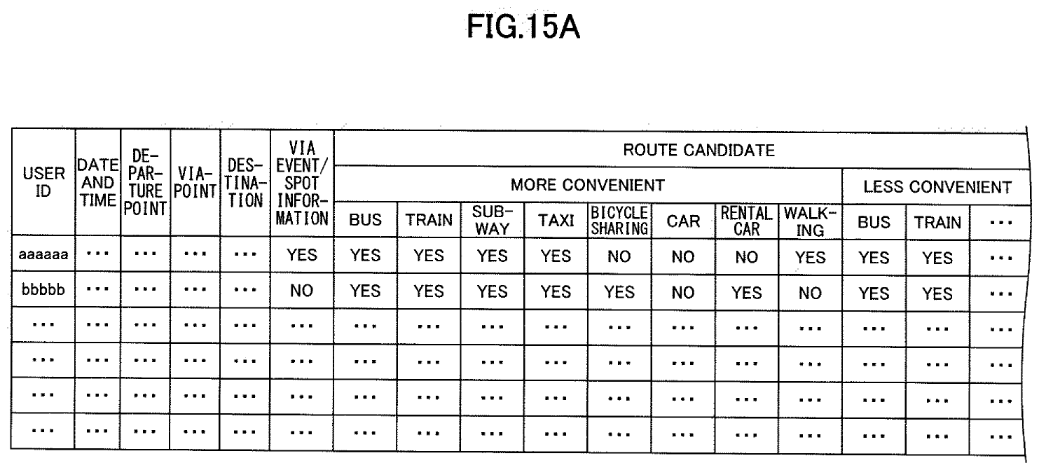

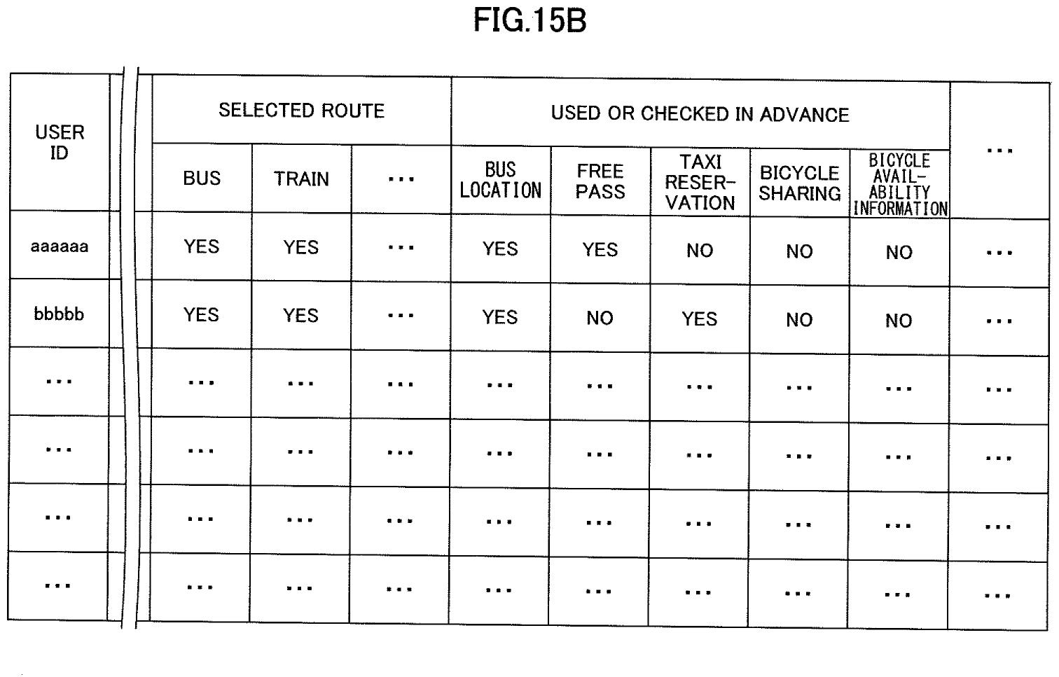

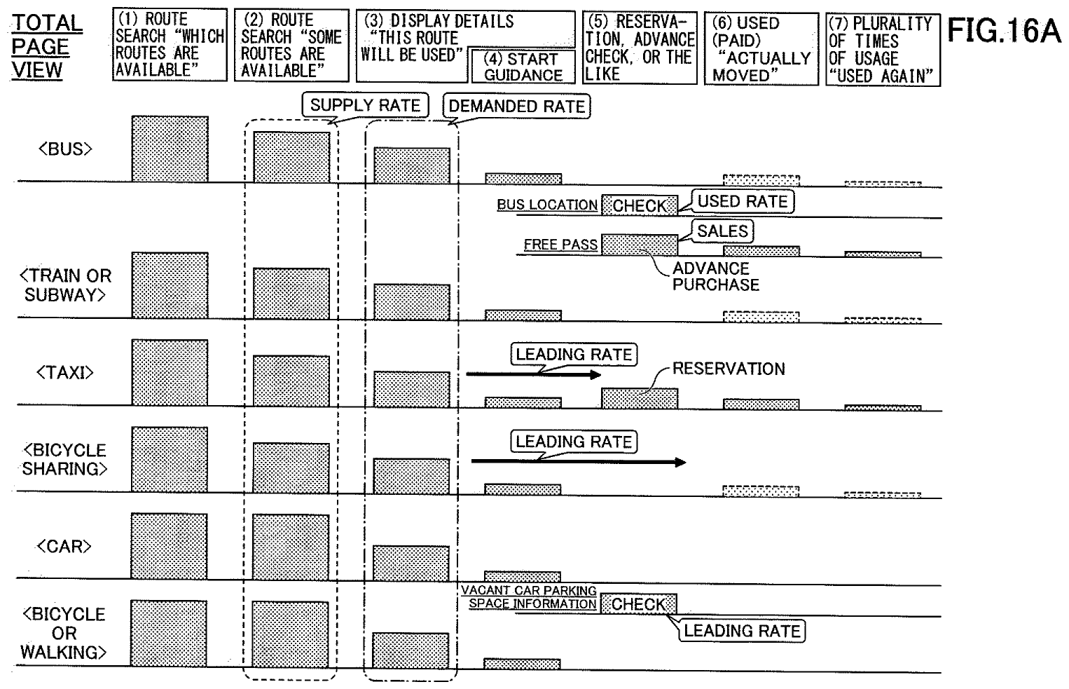

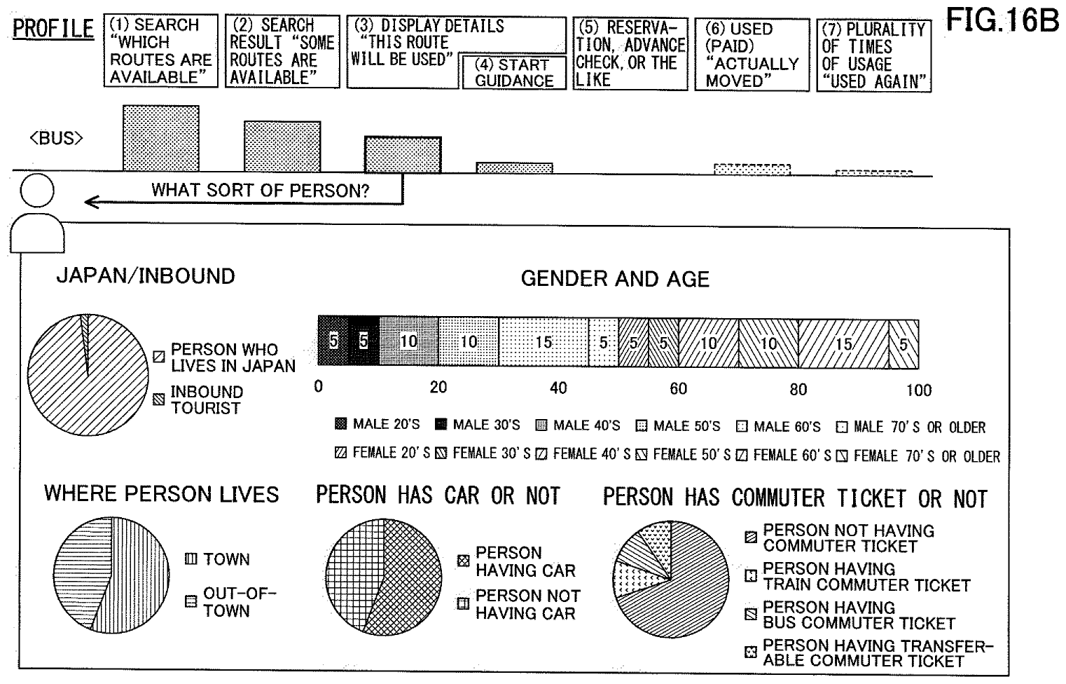

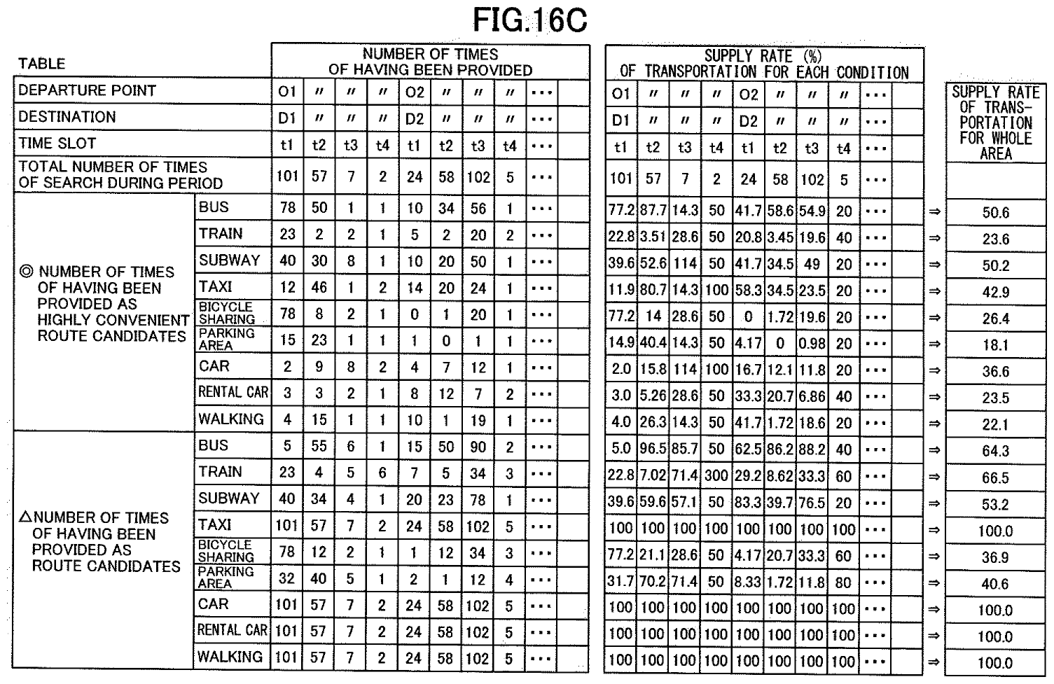

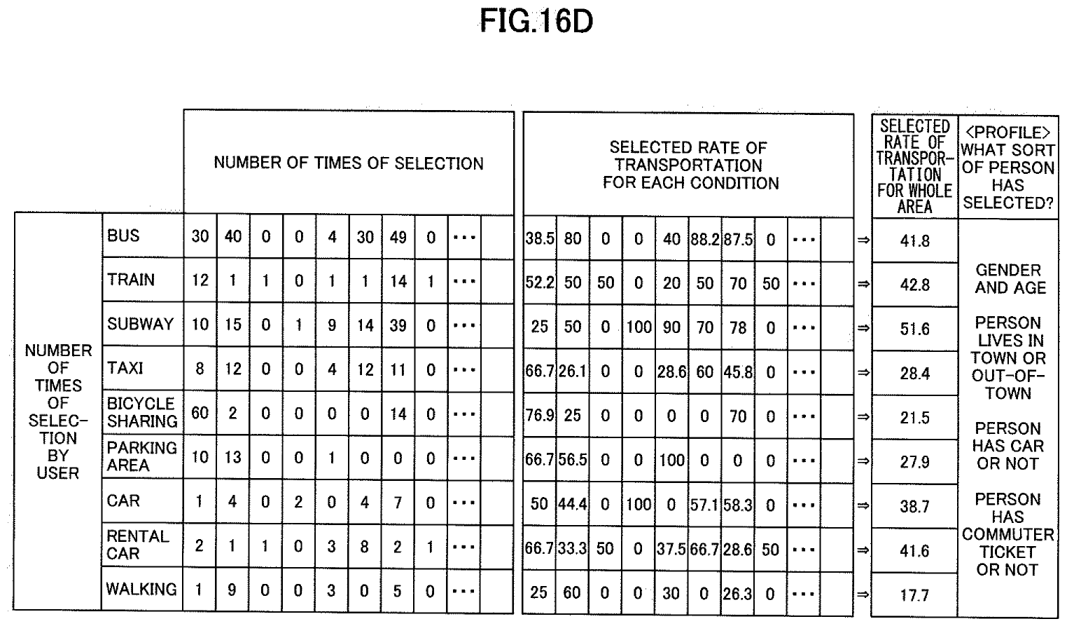

The macro data generating unit 206 (an example of one or more processors configured to perform calculation and data generation) generates history data of multimodal route search results output from the route search unit 201 in response to route search requests from a plurality of users, i.e., output data (hereinafter, referred to as “macro data”) for enabling to know various tendencies of users' moving from a macro viewpoint on the basis of a record group of past multimodal route search results, stored in the route search result history storage unit 207. Details of how to generate macro data and so forth will be described later (see FIGS. 15A-16D).

The macro data generating unit 206 may be included in, for example, another server (an example of a data generating apparatus), such as a server dedicated to macro data generation, communicably connected with the center server 20 having the multimodal route search functions.

As described above, the route search result history storage unit 207 (an example of one or more processors configured to store information) stores multimodal route search results output from the route search unit 201. In more detail, the route search result history storage unit 207 stores records corresponding to multimodal route search results in the route search result history storage unit 207 every time a multimodal route search result is output by the route search unit 201 in response to a route search request, and thus stores the record group of past multimodal route search results as a database of history data (an example of history information) of the multimodal route search results.

The route search result history storage unit 207 may be included in another server or the like, communicatively connected with the center server 20 having the multimodal route search functions, such as a server dedicated to storing history data of multimodal route search results, a server dedicated to generating macro data described above, or the like. The same is applied to the macro data storage unit 208 that will now be described.

The macro data storage unit 208 stores macro data generated by the macro data generating unit 206.

### [Details of Route Search Requesting Method]

Referring now to FIGS. 4-6C, a method for a user to request a multimodal route search to the center server 20 using the mobile terminal 10 will be described later in more detail.

FIG. 4 illustrates an example of an operation method for a user to request a multimodal route search. In more detail, FIG. 4 illustrates an example of an application screen page (an application screen page 400) for transmitting a route search request of the route search application from the mobile terminal 10 to the center server 20.

As illustrated in FIG. 4, the application screen page 400 displayed on the display device 16 of the mobile terminal 10 includes a route search button 401, a departure point box 402, a destination box 403, a via-point box 404, a staying time setting menu 405, a departure time setting menu 406, a map display area 407, and a route search execution button 408.

The route search button 401 is at the left end of a group of buttons in a fixed display area extending horizontally at the bottom of each of all application screen pages of the route search application. A user can display the application screen page 400 on the display device 16 through an operation to select and confirm the selection of (for example, touching a corresponding position on a touch panel) the route search button 401 from any application screen page of the route search application.

The departure point box 402 is used to set a departure point for a multimodal route search. The user may set a desired departure point to the departure point box 402. For example, the departure point box 402 may be defaulted to be the present location of the mobile terminal 10 positioned by a GNSS (Global Navigation Satellite System) device, such as a GPS (Global Positioning System) device mounted in the mobile terminal (see FIG. 4). A configuration may be provided such that, in response to a user inputting a facility name or a keyword corresponding to a desired departure point to the departure point box 402, a departure point list corresponding to the input facility name or keyword is displayed, wherefrom the user can select (set) a desired departure point from the displayed list. The same is applied to setting to the destination box 403 and the via-point box 404.

The destination box 403 is used to set a destination for a multimodal route search. The user may set a desired destination to the destination box 403.

The via-point box 404 is used to set a via-point for a multimodal route search. The user may set a desired via-point to the via-point box 404.

A via-point need not be set.

The stay time setting menu 405 is used to set a stay time for a multimodal route search at a via-point. For example, through an operation of a user to select and confirm the selection of the staying time setting menu 405, a drum-type setting menu for the user to set a stay time is displayed in the application screen page in a superposing manner; the user then can set, using the drum-type setting menu, a stay time that is set to the via-point box 404. The same is applied to setting a departure time using the departure time setting menu 406. In the example of FIG. 4, a stay time is set as “1 hour 30 minutes” with the use of the stay time setting menu 405.

A stay time at a via-point need not be set.

The departure time setting menu 406 is used to set a departure time from the departure point for a multimodal route search. This allows a user to set a departure time from the departure point that is set to departure point box 402. In the example illustrated in FIG. 4, a departure time is set as “immediate departure” corresponding to the current time.

The map display area 407 displays a map image of an area including the departure point, the destination, and the via-point that are set to the departure point box 402, the destination box 403, and the via-point box 404. The map image of the map display area 407 is superposed with images corresponding to the departure point, the destination, and the via-point to be used as landmarks. This allows the user to know the relationships among the departure point, the destination and the via-point in the map.

The route search execution button 408 is used to perform a multimodal route search according to the contents set to the departure point box 402, the destination box 403, the via-point box 404, the stay time setting menu 405, and the departure time setting menu 406. In more detail, by performing an operation to select and confirm the selection of the route search execution button 408, the user can transmit from the mobile terminal 10 to the center server 20 a route search request containing the contents set to the departure point box 402, the destination box 403, the via-point box 404, the stay time setting menu 405, and the departure time setting menu 406.

Thus, a user can set search details for a multimodal route search through the application screen page 400 so that the center server 20 performs the multimodal route search according to the set search details.

FIGS. 5A and 5B illustrate another example of an operation method for a user to request a multimodal route search. In more detail, FIG. 5A illustrates an example of an application screen page (an application screen page 500) of the route search application for performing a search (hereinafter, an “event/spot search”) for an event or POI (a spot). FIG. 5B illustrates a specific example of an application screen page including details of an event or a spot selected from among search results included in the application screen page 500 and illustrates another example (an application screen page 510) of an application screen page in the route search application for transmitting a route search request from the mobile terminal 10 to the center server 20.

The application screen page 510 of FIG. 5B illustrates the entire area that can be displayed on the display device 16 of the mobile terminal 10 section by section with a scrolling operation performed to the input device 17; only a section along a vertical direction of the application screen page 510 is actually displayed on the display device 16 at a time.

As illustrated in FIG. 5A, the application screen page 500 displayed on the display device 16 of the mobile terminal 10 includes an event/spot search button 501, an event/spot search box 502, a search category selection button group 503, and a search result display area 504.

Similar to the route search button 401 of FIG. 4, the event/spot search button 501 is included in the fixed display area of each of all application screen pages of the route search application and is at the second from the right of the group of buttons in this area. The user can display the application screen page 500 on the display device 16 through an operation to select and confirm the selection of the event/spot search button 501 on any application screen page of the route search application.

The event/spot search box 502 is used to input a keyword of a place where the user desires to visit, a thing the user desires to do, or the like according to which the mobile terminal 10 performs an event/spot search.

The search category selection button group 503 is used to select a category for which an event/spot search is performed according to a keyword input to the event/spot search box 502. In the example of FIG. 5A, four search category selection buttons are provided for “play”, “go out”, “purchase”, and “eat”. The user may input a keyword to the event/spot search box 502, and perform an operation to select and confirm the selection of any one of the four search category selection buttons so that the mobile terminal 10 performs an event/spot search according to the input keyword and the category corresponding to the selected search category selection button. At this time, the mobile terminal 10 may perform an event/spot search, for example, through a WebAPI for event/POI searches provided by the event and POI related server 58.

The search result display area 504 displays a result of an event/spot search. In more detail, the search result display area 504 may display summary information of events/spots picked up from the event/spot search (for example, illustrative images of events/spots, event/spot names, information of event/spot locations, or the like) as icons, for example. The contents to be displayed in the search result display area 504 can be scrolled up and down by a scrolling operation of the user with the input device 17. This allows the user to view the summary of search results, i.e., at least either a plurality of events or a plurality of spots obtained from the event/spot search with a scrolling operation. The same is applied to a display manner of a search result of a vicinity information search that will be described later (see FIG. 6B). The user may perform an operation to select and confirm the selection of an event or spot from among the plurality of events or spots displayed in the search result display area 504, thereby changing the display contents of the display device 16 to an application screen page 510 for displaying detailed information of the selected event or spot.

As illustrated in FIG. 5B, the application screen page 510 displayed on the display device 16 of the mobile terminal 10 includes an event/spot detail display area 511, a map display area 512, and a route search execution button 513.

The event/spot detail display area 511 is used to display detailed information of an event or a spot selected from the search results of the application screen page 500 through the user's operation.

The map display area 512 displays a map image including the location of the event or spot for which details are displayed in the event/spot detail display area 511; a superposed image indicating the location of the event or spot is included in the map image. This allows the user to know geographical information of the vicinity including the location of the event or the spot.

The route search execution button 513 is used to execute a multimodal route search for the location of the event or the spot that is set to the destination for which the detailed information is displayed in the event/spot detail display area 511. For example, a configuration may be provided such that, as a result of the user performing an operation to select and confirm the selection of the route search execution button 513, a route search request is transmitted from the mobile terminal 10 to the center server 20. The route search request that is thus transmitted indicates that the present location of the user, that is, the present location of the mobile terminal 10 measured by the GNSS device mounted on the mobile terminal 10 is the departure point; the location of the event or the spot is the destination; and the current time is the departure time, for example. Also a configuration may be provided such that, as a result of the user performing an operation to select and confirm the selection of the route search execution button 513, the display contents of the display device 16 are changed to the application screen page 400 where the event or the spot location has already been set to the destination box 403 (see FIG. 4).

Thus, a user can set the location of an event or a spot found from an event/spot search result as a destination through the application screen pages 500 and 510 according to which the center server 20 performs a multimodal route search.

FIG. 6A-6C illustrate yet another example of an operation method for a user to request a multimodal route search. FIG. 6A illustrates an example (an application screen page 600) of an application screen page where a map image including a part or all of the route of a route candidate as a multimodal route search result of the route search application is displayed. FIG. 6B illustrates an example (an application screen page 610) of an application screen page where a search result of vicinity information is displayed under a geographical condition that is within the range of the map image displayed in the application screen page 600. FIG. 6C is an example of an application screen page displaying details such as an event selected from among search results of vicinity information of the application screen page 610, and is another example of an application screen page (an application screen page 620) for sending a route search request of the route search application from the mobile terminal 10 to the center server 20.

The application screen page 600 of FIG. 6A is displayed on the display device 16 in response to a predetermined operation of a user onto an application screen page 810 (with reference to FIG. 8B) that is a detailed display of a route candidate of a multimodal route search result that will be described later. The application screen page 620 of FIG. 6C corresponds to the entire area that can be displayed on the display device 16 section by section with a scrolling operation performed to the input device 17 of the mobile terminal 10; only a section of the application screen page 620 along a vertical direction is actually displayed on the display device 16 at a time.

As illustrated in FIG. 6A, the application screen page 600 displayed on the display device 16 of the mobile terminal 10 includes a map display area 601 and a search category selection button group 602.

The map display area 601 is used to display a map image of a range to include a part or all of the route of a route candidate included in a multimodal route search result. In the example of FIG. 6A, a map image of a range including a transfer station (“ΔΔΔ station”) of a route candidate is displayed in the map display area 601.

The search category selection button group 602 is superposed at a lower end of the map display area 601 and is used to select a category to be used for performing a search of vicinity information (hereinafter, a “vicinity information search”) under a geographical condition that is within the area of the map image displayed in the map display area 601. In the example of FIG. 6A, there are eight search category selection buttons corresponding to the following categories: “play”, “go out”, “purchase”, “eat”, “parking area”, “port”, “bus stop”, and “rental car”. The “port” means a cycle port for bicycle sharing. The user may perform an operation to select and confirm the selection of one of the eight search category selection buttons so that the mobile terminal 10 performs a vicinity information search under the geographical condition that is within the area of the map image for the category corresponding to the selected search category selection button.

At this time, the mobile terminal 10 may perform the vicinity information search using, for example, web APIs for searching for a bus stop of a fixed route bus, a rental car sales office, a bicycle sharing cycle port, and a parking area, provided by the fixed route bus related server 30, the rental car related server 46, the bicycle sharing related server 48, and the parking area related server 56. As a result, the display contents displayed on the display device 16 of the mobile terminal are changed from the application screen page 600 to the application screen page 610.

As illustrated in FIG. 6B, the application screen page 610 displayed on the display device 16 of the mobile terminal 10 includes a map display area 611 and a search result display area 612.

The map display area 611 is used to display a range of a map image including facilities corresponding to the results of the vicinity information search. The map image of the map display area 611 is superposed with sign images 611A indicating the locations of the events or facilities, which are output as the search results of the vicinity information search.

The search result display area 612 is used to display the search results of the vicinity information search. In more detail, the search result display area 612 may display summary information of the events or the facilities picked up by the vicinity information search in a list format or the like. The user may perform an operation to select and confirm the selection of an event or facility from among the plurality of events or facilities displayed in the search result display area 612, resulting in a change of the display contents of the display device 16 to the application screen page 620 for displaying detailed information of the selected event or facility.

As illustrated in FIG. 6C, the application screen page 620 displayed on the display device 16 of the mobile terminal 10 includes a vicinity information detail display area 621, a map display area 622, a destination setting button 623, and a via-point setting button 624.

The vicinity information detail display area 621 is used to display detailed information of an event, a facility or the like selected by a user's operation from among the search results of the application screen page 610.

The map display area 622 displays a map image including the location of the event, facility, or the like for which the detailed information is displayed in the vicinity information detail display area 621; a sign image 622A indicating the location of the event, facility or the like is included in the map image in a superposing manner. This allows the user to obtain geographical information of the vicinity including the location of the event, spot, or the like.

The destination setting button 623 is used to set, as a destination, the location of the event, facility, or the like for which the detailed information is displayed in the vicinity information detail display area 621 so that a multimodal route search is to be performed again. The via-point setting button 624 is used to set, as a via-point, the location of the event, facility, or the like for which the detailed information is displayed in the vicinity information detail display area 621 so that a multimodal route search is to be performed again.

For example, a configuration may be provided such that the user may perform an operation to select and confirm the selection of the destination setting button 623 or the via-point setting button 624 so that the mobile terminal 10 transmits a route search request to the center server 20 where only the destination or via-point is changed to the location of the event, facility, or the like while the other search conditions are kept unchanged from the original multimodal search request.

Also a configuration may be provided such that the user may perform an operation to select and confirm the selection of the destination setting button 623 or the via-point setting button 624 so that the display contents of the display device 16 are changed to the application screen page 400 where the location of the event, the facility, or the like has been already set to the destination box 403 or the via-point box 404 while the other search conditions are kept unchanged from the original multimodal search request.

Thus, using the application screen pages 600 to 620, a user can set the location of an event, facility, or the like, found from a search result of a vicinity information search concerning a route candidate of a multimodal route search result, as a destination or a via-point so that a multimodal route search will be performed.

### [Details of Multimodal Route Search Method]

Next, a multimodal route search by the center server 20 (the route search unit 201) will now be described in detail with reference to FIG. 7. Below, mainly characteristic portions of the multimodal route search method according to the present embodiment will now be described.

FIG. 7 illustrates an example of an application screen page (an application screen page 700) where a plurality of predetermined types of transportation for the route search application are selected from among a plurality of available types of transportation.

The route search unit 201 performs a multimodal route search using one or more of the plurality of predetermined types of transportation and outputs one or more route candidates on the basis of search conditions including a departure point and a destination included in a route search request (for example, the conditions set in the application screen page 400 of FIG. 4).

At this time, as described above, the plurality of predetermined types of transportation may be selectable by a user from among a plurality of available types of transportation: the user may select the plurality of predetermined types of transportation, for example, from the application screen page 700 illustrated in FIG. 7. In other words, the user can change basic search conditions for a multimodal route search performed by the route search unit 201.

For example, as illustrated in FIG. 7, a plurality of types of transportation (“walking”, “train”, “fixed route bus”, “ship or water-bus”, “limited train or SHINKANSEN”, “expressway bus”, “airplane”, “taxi”, “bicycle sharing”, “bicycle”, “car”, “rental car”, and “car sharing”) that are candidates for the predetermined types of transportation are displayed in the application screen page 700 along a vertical direction.

Among the candidates for the predetermined types of transportation, “walking” and “train” are fixed as predetermined types of transportation. That is, in the present embodiment, the route search unit 201 performs a multimodal route search using one or more from among the predetermined types of transportation including at least “train” and “walking”. As for each of the remaining candidates of the predetermined types of transportation (“fixed route bus”, “ship or water-bus”, “limited train or SHINKANSEN”, “expressway bus”, “airplane”, “taxi”, “bicycle sharing”, “bicycle”, “car”, “rental car”, and “car sharing”), a selection (ON/OFF) as a predetermined type of transportation is switched by the user with the use of a slide switch installed next to each of the candidate names of the corresponding types of transportation in the application screen page 700.

By performing an operation to select or not select each of the candidates for the predetermined types of transportation on the application screen page 700 and an operation to select and confirm the selection of the button “FINISH” at the top right corner of the application screen page 700, the user can transmit the information of the types of transportation thus selected on the application screen page 700 from the mobile terminal 10 to the center server 20 and reflect the selected types of transportation as the basic conditions for a route search of the route search unit 201 (hereinafter, referred to as “basic route search conditions”).

Thus, the route search unit 201 can perform a multimodal route search on the basis of the basic route search conditions that have been thus set through the application screen page 700 and reflected in the center server 20 and other search conditions set as a route search request received from the mobile terminal 10.

In the example of FIG. 7, “railway” is further classified into two categories “train” and “limited train or SHINKANSEN” as candidates for predetermined types of transportation, but need not be further classified and may be in a single category. In addition, in this example, “ship” and “water bus” are in a single category as “ship or water bus” and treated as one predetermined type of transportation, but a ship and a water bus may be separately classified and treated as separate candidates for predetermined types of transportation.

Further, for a case of searching for a candidate route that uses shared type transportation, the route search unit 201 may limit a route segment using a shaped type of transportation. In more detail, the route search unit 201 may perform a route search from a departure point to a destination including a use of shared type transportation in such a manner that a route search is limited to at least one of a use of shared type transportation from a departure point or the vicinity of the departure point and a use of shared type transportation up to a destination or the vicinity of the destination. The term “the vicinity of the departure point” and “the vicinity of the destination” mean areas of predetermined distances (for example, 2 kilometers) from the departure point and the destination, respectively.

For a case of using shared type transportation in a route search, the degree of freedom for a selection of a route segment using shared type transportation is relatively high. That is, in a case of a route search assuming a use of a private car or bicycle, it is necessary to secure a parking space. Therefore, in many cases, a route search assumes a use of a car or a bicycle throughout the course from a departure point to a destination. In contrast thereto, for a case of using shared type transportation, such a pattern as using shared type transportation only for a route segment is relatively easily feasible. This is because access points for transportation (for example, rental car sales offices, car sharing stations, bicycle sharing ports, or the like) are at various places or it may be possible to get on and off transportation at any place (for example, for a case of a taxi, ride sharing, or the like). In addition, for a case of using shared type transportation, because a travel route is not fixed in contrast to a case of using a bus or train having a relatively large passenger capacity, the degree of freedom for a route is also high. Therefore, in a case of using shared type transportation for a multimodal route search, it may be impossible to complete the route search within a realistic time.

In contrast thereto, by limiting a route segment using shared type transportation for a multimodal route search as described above, it is possible to control the increase in the number of available patterns of combining another type of transportation such as public transportation. Also, because either a start point or an end point of using shared type transportation is limited to a departure point or the vicinity thereof or a destination or the vicinity of the destination, the freedom for a route can be reduced in comparison to a case where both the start point and the end point using shared type transportation are not limited. Thus, it is possible to control the increase in the number of available patterns of combining various types of transportation including another type of transportation such as public transportation, and therefore, the center server 20 (the route search unit 201) can complete a multimodal route search within a realistic time.

Shared type transportation as a predetermined type of transportation may include at least one of a rental car, car sharing, bicycle sharing, ride sharing, and a taxi, as described above.

Thus, the center server 20 (the route search unit 201) can complete a multimodal route search including a rental car, car sharing, bicycle sharing, ride sharing, a taxi, or the like as specific shared type transportation within a realistic time.

In more detail, the route search unit 201 may perform a multimodal route search from a departure point to a destination including a use of a rental car in such a manner that the route search unit 201 limits a use of a rental car to at least one of a use of a rental car from a sales office in the vicinity of the destination and a use of a rental car to a sales office in the vicinity of the destination.

The route search unit 201 may perform a multimodal route search from a departure point to a destination including a use of car sharing in such a manner that the route search unit 201 limits a use of car sharing to at least one of a user of car sharing from a car sharing station in the vicinity of the departure point and a use of car sharing up to a car sharing station in the vicinity of the destination.

The route search unit 201 may perform a multimodal route search from a departure point to a destination including a use of bicycle sharing in such a manner that the route search unit 201 limits a use of car sharing to at least one of a user of car sharing from a cycle port in the vicinity of the departure point and a use of car sharing up to a cycle port in the vicinity of the destination.

That is, the route search unit 201 may perform a multimodal route search from a departure point to a destination including a use of shared type transportation in such a manner that a use of a rental car, car sharing, or bicycle sharing is limited to at least one of a use from a corresponding transportation access point in the vicinity of the departure point and a use up to a corresponding transportation access point in the vicinity of the destination.

Thus, the center server 20 (the route search unit 201) can perform a multimodal route search including a use of shared type transportation in a manner to be suitable to characteristics of the shared type transportation, such as a rental car, car sharing, bicycle sharing, or the like, such that getting on and off transportation is required to be performed at corresponding access points.

The route search unit 201 may perform a multimodal route search from a departure point to a destination including a use of shared type transportation in such a manner that a use of ride sharing or a taxi is limited to at least one of a use from the departure point and a use up to the destination.

Thus, the center server 20 (the route search unit 201) can perform a multimodal route search including a use of shared type transportation in a manner to be suitable to characteristics of the shared type transportation, such as ride sharing or a taxi, such that locations of getting on and off transportation can be freely determined.

The upper limit of a transportation-using distance in a multimodal route search (hereinafter, a “maximum search distance”) may be determined for each of various types of shared type transportation. For example, for a taxi, the maximum search distance (for example, 100 kilometers) may be used. This is because, as the distance is too long, the taxi fare may exceed the realistic range that the user is willing to pay, making it meaningless to provide as a route candidate. For each of bicycle sharing and walking, the maximum search distance (for example, 10 kilometers) may be used. Because of users' physical limits, bicycle sharing and walking may be meaningless to provide as route candidates if the distances are too long.

### [Details on how to Display Route Search Result]

Next, a method of displaying a route search result on the mobile terminal 10 will be described later in more detail with reference to FIGS. 8A, 8B and 9.

FIGS. 8A and 8B illustrate examples of display screen pages of multimodal route search results. Specifically, FIG. 8A illustrates an example of a display screen page (an application screen page 800) for displaying a list of a plurality of route candidates of a multimodal route search result. FIG. 8B illustrates an example (an application screen page 810) of an application screen page displaying detailed contents of one of a plurality of route candidates of a multimodal route search result. FIG. 9 illustrates an example of a method of determining types of transportation whose names are to be displayed in association with route candidates.

The application screen pages 800 and 810 of FIGS. 8A and 8B illustrate the entire areas each of which can be displayed on the display device 16 section by section with a scrolling operation performed to the input device 17 of the mobile terminal 10; only a section of each of the application screen pages 800 and 810 along a vertical direction is actually displayed on the display device 16 at a time. Therefore, the user can view the entire area of the application screen page 800 or 810 by performing a scrolling operation along a vertical direction through the input device 17 of the mobile terminal 10. The same is applied also to application screen pages 1000, 1200, and 1300 of FIG. 10A, FIG. 12A, and FIG. 13A, which will be described later.

As illustrated in FIG. 8A, the application screen page 800 displayed on the display device 16 of the mobile terminal 10 includes route candidate display areas 801-808 corresponding to a plurality of route candidates, which are set in the order from top to bottom.

A route candidate display area 801, which is set at the top, includes a route candidate of first walking from a departure point to a cycle port for bicycle sharing in the vicinity of a departure point, then moving by a shared bicycle from the cycle port for bicycle sharing in the vicinity of the departure point to a cycle port for bicycle sharing in the vicinity of a train station (“□□ line, XX station”), then moving by trains from the train station to get on a train to a train station to get off a train through a connection of two train lines, and finally walking from the train station to the destination (see the 4th display area 801D that will be described later).

A route candidate display area 802, which is set to the second from the top, displays a route candidate of first moving by taxi from the departure point to a train station (“◯◯ line, ΔΔ station”) to get on a train, then moving by trains from the train station to a train station to get off a train through connections of three train lines, and finally walking from the train station to the destination (see the 4th display area 802D that will be described later).

A route candidate display area 803, which is set to the third from the top, displays a route candidate first walking from the departure point to a train station (“◯◯ line, X X station”) to get on a train, then moving by trains from the train station to a train station to get off a train through connections of three train lines, and finally walking from the train station to the destination (see the 4th display area 803D that will be described later).

A route candidate display area 804, which is set to the fourth from the top, displays a route candidate of first walking from the departure point to a fixed route bus stop (“◯◯ line, AA bus stop”) in the vicinity of the departure point, then moving by a fixed route bus from the bus stop to a train station to get on a train, then moving by trains from the train station to a train station to get off a train through connections of three train lines, and finally walking from the train station to the destination (see the 4th display area 804D that will be described later).

A route candidate display area 805, which is the fifth from the top, displays a route candidate of first walking from the departure point to a rental car office in the vicinity of the departure point, then moving by a rental car from the rental car office to a rental car office in the vicinity of the destination, and finally walking from the rental car office in the vicinity of the destination to the destination (see the 4th display area 805D that will be described later).

A route candidate display area 806, which is set to the sixth from the top, displays a route candidate of first walking from the departure point to a car sharing station in the vicinity of the departure point, then moving by a shared car from the car sharing station in the vicinity of the departure point to a car sharing station in the vicinity of the destination, and finally walking from the car sharing station in the vicinity of the destination to the destination (see the 4th display area 806D that will be described later).

A route candidate display area 807, which is set to the second from the bottom, displays a route candidate of moving by car from the departure point to the destination (see the 4th display area 807D that will be described later).

A route candidate display area 808, which is set at the bottom, displays a route candidate of moving by a bicycle from the departure point to the destination (see the 4th display area 808D that will be described later).

The six route candidates corresponding to the route candidate display areas 801-806 are sorted according to a common condition (hereinafter, a “common condition”) that is set regardless of the plurality of predetermined types of transportation, such as, for example, the order of arrival, the ascending order of fare, the ascending order of the number of transfers, or the like, and are displayed in the order from top to bottom. In the example of FIG. 8A, the six route candidates are sorted from top to bottom in the order of destination arrival.

The two route candidates corresponding to the route candidate display areas 807 and 808 are at fixed positions, after (in the example, under) the other six route candidates among the eight route candidates, in the order according to a condition (hereinafter, a “specific condition”) specific to the predetermined types of transportation used for the corresponding route candidates regardless of the above-mentioned common condition. This is because the likelihood that users who use multimodal route searches preferentially select route search results using private cars or bicycles seems to be relatively low.

That is, considering this point, it is sufficient that route candidates using only a private car and bicycle are provided to a user as comparison objects for the other route candidates. Therefore, the search result delivery unit 202 may generate such route search result delivery data where the display order of a specific route candidate using only a car or a bicycle among a plurality of route candidates is such that the specific route candidate occurs subsequent to the other route candidates, and deliver the data to the mobile terminal 10.

The order of display between a route candidate using only a car and a route candidate using only a bicycle may be, as illustrated in FIG. 8A, such that the route candidate using only a car is earlier than the route candidate using only a bicycle; or the route candidate using only a bicycle is earlier than the route candidate using only a car. The order of display between a route candidate using only a car and a route candidate using only a bicycle may be determined according to a common condition described above (for example, order of arrival, order of the fare amount, or the like).

Display details of a particular route candidate using a predetermined type of transportation other than a car and a bicycle may be determined according to a specific condition predetermined for the predetermined type of transportation.

For example, the search result delivery unit 202 displays a route candidate using a taxi as a route search result on the display device 16 of the mobile terminal 10 for a case where the taxi-using distance in the route candidate is relatively short. The display order of the route candidate among a plurality of route candidates may be determined on the basis of a common condition. That is, the display details of a route candidate may be determined by first applying a specific condition and then, further applying a common condition. The same is applied to other route candidates. In contrast thereto, for a case where the taxi-using distance is relatively long, the search result delivery unit 202 may avoid displaying the route candidate as a route search result on the display device 16 of the mobile terminal 10.

In more detail, for a case where the taxi-using distance in the route candidate is less than a predetermined threshold (hereinafter, “first threshold”) (for example, 15 kilometers), the search result delivery unit 202 may display the route candidate as a route search result on the display device 16 of the mobile terminal 10, whereas, for a case where the taxi-using distance in the specific route candidate is greater than or equal to the first threshold, the search result delivery unit 202 may avoid displaying the route candidate as a route search result on the display device 16 of the mobile terminal 10. As a taxi-using distance is increased to a certain extent, the user's selecting of the route candidate seems to be greatly reduced taking into account the fare or the like. In this regard, the route candidate may be a route candidate using a taxi in combination with another transportation and also may be a route candidate using only a taxi.

Also for a route candidate using ride sharing, whether to display the route candidate as a route search result to the display device 16 of the mobile terminal 10 may be determined according to a similar specific condition (i.e., whether the usage distance of ride sharing is greater than or equal to the first threshold). That is, for a case where the usage distance of at least one of a taxi and ride sharing in a route candidate using the at least one of the taxi and ride sharing is less than the first threshold, the search result delivery unit 202 may display the route candidate as a route search result on the display device 16 of the mobile terminal 10, whereas, for a case where the usage distance of the at least one of a taxi and ride sharing in the route candidate is greater than or equal to the first threshold, the search result delivery unit 202 may avoid displaying the route candidate as a route search result on the display device 16 of the mobile terminal 10. In this regard, for the case where the usage distance of the at least one of a taxi and ride sharing in the route candidate using the at least one of a taxi and ride sharing is relatively long, the search result delivery unit 202 may, instead of avoiding displaying the route candidate, display the route candidate later than the display order determined by a common condition.

The search result delivery unit 202 displays a route candidate using walking, for example, as a route search result on the display device 16 of the mobile terminal 10 for case where the usage distance of walking in the route candidate is relatively short, that is, less than a predetermined threshold (hereinafter, a “second threshold”) (for example, 1.2 kilometers). In contrast thereto, for a case where the usage distance of walking in the route candidate is relatively long, that is, equal to or greater than the second threshold, the search result delivery unit 202 may avoid displaying the route candidate as a route search result on the display device 16 of the mobile terminal 10. This is because, in a case of a route candidate using walking, as the usage distance of walking is relatively long, the user's selecting the route candidate may be greatly reduced in view of physical exhaustion, the required time, and so forth. In this regard, for a case where the usage distance of walking in a route candidate using walking is relatively long, the search result delivery unit 202 may, instead of avoiding displaying the route candidate, display the route candidate later than the display order determined by a common condition.

For a route candidate using transportation (public transportation) for which an operation schedule including the route and the time of operation is previously determined such as a railway, a bus, an airplane, a ship, or the like, the search result delivery unit 202 displays the route candidate as a route search result on the display device 16 of the mobile terminal 10 for a case where, for example, the transfer time of public transportation of the same type or different types is relatively short, that is, less than a predetermined threshold (hereinafter referred to as a “third threshold”). In contrast thereto, the search result delivery unit 202 may avoid displaying the route candidate as a route search result on the display device 16 of the mobile terminal 10 for a case where the transfer time of the public transportation is relatively long, that is, is greater than or equal to the third threshold. This is because a longer transfer time significantly reduces the convenience of the user and may reduce the likelihood of selection of the corresponding route candidate by the user. For a case where the transfer time of public transportation in the route candidate using public transportation is relatively long, the search result delivery unit 202 may, instead of avoiding displaying the route candidate, display the route candidate later than the display order determined by a common condition.

Thus, the search result delivery unit 202 displays a route candidate using a type of transportation among a plurality of route candidates on the display device 16 of the mobile terminal 10 on the basis of display details, concerning at least one of the display order among the plurality of route candidates and whether to display the route candidate, determined according to a specific condition determined for the type of transportation among the plurality of predetermined types of transportation.

In this regard, criteria by which a user selects one route candidate from among a plurality of route candidates may depend on the predetermined types of transportation used in the route candidates. As described above, the center server 20 can reflect a specific condition of a type of transportation in display details of a route candidate using the type of transportation. Therefore, for example, by previously determining a specific condition of a type of transportation to reflect criteria for a user to select a route candidate using the type of transportation, the center server 20 can improve the convenience for a user to select one route candidate from among a plurality of route candidates.

Further, the search result delivery unit 202 may display route candidates other than a certain route candidate among a plurality of route candidates on the display device 16 of the mobile terminal 10 on the basis of display details concerning the display order among the plurality of route candidates determined according to a common condition determined for the plurality of route candidates; and may display the certain route candidate on the display device 16 of the mobile terminal 10 on the basis of display details concerning the display order among the plurality of route candidates and whether to display the certain route candidate determined according to a specific condition

Thus, the center server 20 may basically display a plurality of route candidates according to a common condition such as an ascending order of required time, while displaying a certain route candidate using a certain type of transportation according to a specific condition.

The search result delivery unit 202 may display a certain route candidate on the display device 16 of the mobile terminal 10 on the basis of display details, concerning the display order among a plurality of route candidates and whether to display the certain route candidate, determined according to a common condition and a specific condition that is preferentially used over the common condition.

Thus, under the situation where a common condition can be applied to a certain route candidate using a certain type of transportation after a specific condition is preferentially applied, the center server 20 can apply the common condition and display the certain route candidate to the user terminal (the mobile terminal 10) under the common condition.

As illustrated in FIG. 8A, the route candidate display areas 801-808 include the first display areas 801A-808A, the second display areas 801B-808B, the third display areas 801C-808C, the fourth display areas 801D-808D, and the fifth display areas 801E-808E, respectively.

The first display areas 801A-808A laterally extend at the upper ends (the tops) of the respective route candidate display areas 801-808. In each of the first display areas 801A-808A, the name (that may be an abbreviation or a nickname) of one type of transportation of the types of transportation used for the corresponding route candidate is displayed.

The first display areas 807A and 808A each using the one type of transportation include the respective names of the only one type of transportation used.

In the first display areas 801A-806A corresponding to the route candidates each using two or more types of transportation, the names of one type of transportation used for the corresponding route candidates are displayed. That is, the search result delivery unit 202 displays the name of one of two or more types of transportation on the display device 16 corresponding to the route candidates each using the two or more types of transportation provided by the route search unit 201 and displayed on the display device 16 of the mobile terminal 10.

In a case where route candidates each using two or more types of transportation are included in a plurality of route candidates, if the plurality of route candidates were simply displayed in a row, it might be difficult for a user to intuitively understand which types of transportation are used in the routes included in each of the route candidates. In addition, although the names of all the types of transportation used in the route candidates could be displayed, the display might become complicated for a case where the names of the particular types of transportation included in the route candidates are long, and it might be difficult to encourage the user to understand the display contents intuitively. It is also possible to create a new name for a combination of two or more types of transportation used in a route candidate. However, if so, depending on how to determine the new name, it might be difficult to derive from the new name the original types of transportation used in the route candidate, and as a result, it might be difficult to encourage the user to understand the original types of transportation intuitively.

In this regard, according to the embodiment, as described above, only the name of one type of transportation from among the names of two or more types of transportation used in a route candidate is displayed. Therefore, the user can intuitively understand the one type of transportation. Then the user can use the one type of transportation as a hint to understand to a certain extent also the remaining types of transportation used in the route candidate intuitively from the contents of the route search result displayed on the display device 16 of the mobile terminal 10 and so forth. Thus, the center server 20 can encourage the user to understand the particular types of transportation used in the route candidate using the two or more types of transportation.

For example, as illustrated in FIG. 9, a priority order among a plurality of predetermined types of transportation may be previously determined. Then, the name of the type of transportation having the highest priority among two or more types of transportation may be displayed on the display device 16 of the mobile terminal for a route candidate using the two or more types of transportation.

Thus, by setting the priority order such that a type of transportation by which a user is most likely to characterize a route candidate has a higher priority, the center server 20 can more appropriately encourage the user to understand each of the types of transportation included in the route candidate.

In more detail, the priorities of car sharing, bicycle sharing, ride sharing, and a rental car are set higher than those of public transportation such as an airplane, a ship, an expressway bus, a limited train or SHINKANSEN, a bus, and a train.

Thus, the center server 20 can display, for a route candidate using public transportation as well as a rental car, car sharing, bicycle sharing, ride sharing, or the like, a name such as a rental car, car sharing, bicycle sharing, or ride sharing on the display device 16 of the mobile terminal 10 as a type transportation characterizing the route candidate. It may be advantageously effective that, for example, it is easier to leave an impression on the user by displaying a rental car, car sharing, bicycle sharing, ride sharing, or the like to the user rather than general transportation such as public transportation. Thus, the center server 20 can encourage a user to understand each of the particular types of transportation used in a route candidate using, for example, public transportation as well as a rental car, car sharing, bicycle sharing, or the like.

Furthermore, the priorities of a car, a bicycle, and walking are set lower than those of the other predetermined types of transportation.

Thus, the center server 20 can display, for a route candidate using a car, a bicycle, walking or the like, as well as another type transportation, the name of the other type of transportation as a type of transportation characterizing the route candidate, on the display device 16 of the mobile terminal 10.

Alternatively, for a route candidate using two or more types of transportation, the name of a type of transportation used for the longest distance or the longest time from among the two or more types of transportation may be displayed on the display device 16 of the mobile terminal 10.

For example, a type of transportation used for the longest distance or the longest time in a route search result is considered as one of the most important concerns for the user in selecting a route candidate to actually use from among a plurality of route candidates. Thus, the center server 20 can encourage the user to understand each of the types of transportation included in the route candidate.

Further alternatively, for a route candidate using two or more types of transportation, the name of a type of transportation other than walking and to be used first in a route candidate may be displayed on the display device 16 of the mobile terminal 10.

For example, a type of transportation other than walking and to be used first in a route candidate is considered as one of the most important concerns for the user in selecting a route candidate from among a plurality of route candidates to actually use. Thus, the center server 20 can encourage the user to understand each of the particular types of transportation included in the route candidate.

Returning to FIG. 8A, each of the second display areas 801B-808B extends laterally below the first display areas 801A-808A in the route candidate display areas 801-808, respectively. The second display areas 801B-808B include the departure times, the arrival times, and the times required for the respective route candidates.

The third display areas 801C-808C each extends laterally in the vertical center positions of the route candidate display areas 801-808, respectively. Among the third display areas 801C-808C, the third display areas 801C-804C each includes the name (that may be an abbreviation or a nickname) of a place to first get on public transportation (for example, a railway station, a fixed route bus or expressway bus stop, an airport of airplanes, a port of ships, or the like) to be used first in the corresponding one of the route candidates as well as the corresponding departure time.

Thus, even in a case where the transportation to be used first in a route candidate is not public transportation, the center server 20 can indicate the place to first get on public transportation to be used first and the corresponding departure time. Therefore, the center server 20 can improve the convenience of the user.

The third display areas 805C-808C of the route candidates 805-808, from among the third display areas 801C-808C, not using public transportation in the corresponding route candidates are left blank.

The fourth display areas 801D-808D extend laterally below the third display areas in the route candidate display areas 801-808, respectively. In the fourth display area 801D-808D, icons corresponding to the types of transportation used for the corresponding route candidates are displayed in the transferring orders.

The fifth display areas 801E-808E extend laterally at the lower ends (the lowest places) of the route candidate display areas 801-808, respectively. In the fifth display areas 801E-808E, the numbers of transfers of types of transportation (that may be transfers among the same types of transportation and may be different types of transportation) and the required fares are displayed.

By performing an operation to select and confirm the selection of any one of the route candidate display areas 801-808 from the application screen page 800, the user can change the display contents of the display device 16 to a detailed screen page of the route candidate corresponding to the thus selected one of the route candidate display areas 801-808, that is, for example, the application screen page 810 of FIG. 8B.

As illustrated in FIG. 8B, the application screen page 810 includes a route candidate detail display area 811 and a route guide start button 812.

In the route candidate detail display area 811, details of the one route candidate selected from the application screen page 800 are displayed. In more detail, in the route candidate detailed display area 811, the types of transportation used in the route candidate as well as the departure time and the arrival time of each thereof are displayed in sequence from top to bottom. In addition, the transfer locations or the like between the same types of transportation or between different types of transportation from among the plurality of types of transportation are displayed.

The route guide start button 812 is above the route candidate detail display area 811 and is used by the user to initiate a route guide based on the route candidate displayed in the route candidate detail display area 811. The user may initiate the route guide to be performed by the mobile terminal 10 by performing an operation to select and confirm the selection of the route guide start button 812. In this regard, the mobile terminal 10 may display a predetermined information image on the display device 16 or provide a route guidance by voice, comparing location information and time information obtained from, for example, a GNSS device and a timing device such as a RTC (Real Time Clock) built in the mobile terminal 10 with the departure and arrival locations and the departure and arrival times of the types of transportation used sequentially in the route candidate, and so forth.

### [How to Use Taxi]

Next, a method to use a taxi in response to a user's operation onto the application screen page of the route search application will now be described with reference to FIGS. 10A and 10B.

FIGS. 10A and 10B illustrate an example of a method to use a taxi on the basis of a multimodal route search result. In more detail, FIG. 10A illustrates an example of an application screen page (an application screen page 1000) for displaying details of a route candidate in which a taxi is used, among a plurality of route candidates of a multimodal route search result. FIG. 10B illustrates an example of an application screen page (an application screen page 1010) for a user to reserve a taxi.

As illustrated in FIG. 10A, the application screen page 1000 includes a route candidate detail display area 1001 as in the case of the application screen page 810 of FIG. 8B.

The route candidate detail display area 1001 displays route candidate details including a taxi usage section; a taxi reservation button 1002 is provided in the taxi usage section. The user can change the display contents of the display device 16 of the mobile terminal from the application screen page 1000 to the application screen page 1010 for reserving a taxi by performing an operation to select and confirm the selection of the taxi reservation button 1002.

As illustrated in FIG. 10B, the application screen page 1010 includes a map image display area 1011, a reservation operation guidance area 1012, and a point-to-take-taxi setting button 1013.

The map image display area 1011 displays a map image in the vicinity of the taxi departure point of the route candidate displayed in the application screen page 1000.

The reservation operation guidance area 1012 is superposed at a lower end of the map image display area 1011. The reservation operation guidance area 1012 displays an operation guidance text that urges the user to determine the point to take a taxi from the map image of the map image display area 1011.

The point-to-take-taxi setting button 1013 is provided at the right end of the reservation operation guidance area 1012, which does not overlap with the operation guidance text, and is used by the user to set a point to take a taxi.

The user performs, through the input device 17 of the mobile terminal 10, an operation to indicate a desired point to take a taxi in the map image and performs an operation to select and confirm the selection of the point-to-take-taxi setting button 1013 to set the point to take a taxi and, for example, performs such an operation whereby the mobile terminal 10 transmits a taxi reservation request, for example, corresponding to the taxi departure time included in the route candidate to the center server 20.

Thus, without activating a browser, a dedicated application, or the like in the mobile terminal 10 to make a reservation to a taxi company, for example, a user can complete a taxi reservation from the application screen pages 1000 and 1010 displaying information concerning a route candidate of a multimodal route search result. Thus, the convenience of the user can be improved.

Ride sharing, a rental car, car sharing, bicycle sharing, or the like, as a predetermined type of transportation, may also be reserved in the same manner as in the case of a taxi, through an operation performed on an application screen page displaying information concerning a route candidate of a multimodal route search result.

### [Method to View Parking Area Information]

Next, a method to view parking area information in response to a user's operation on an application screen page of the route search application will now be described with reference to FIGS. 11A and 11B.

FIGS. 11A and 11B illustrate an example of a method to view parking area information on the basis of a multimodal route search result. Specifically, FIG. 11A illustrates an example of an application screen page (an application screen page 1100) for displaying details of a route candidate using a car from among a plurality of route candidates of a multimodal route search result. FIG. 11B illustrates an example of an application screen page (an application screen page 1110) for displaying parking area information.

The application screen page 1100 may display a route candidate where a car is used in combination with another type of transportation.

As illustrated in FIG. 11A, the application screen page 1100 includes a route candidate detail display area 1101 as in the case of the application screen page 810 of FIG. 8B.

The route candidate detail display area 1101 displays detailed contents of a route candidate including a car usage section; a parking area information viewing button 1102 is provided in the car usage section. The user can change the display contents of the display device 16 of the mobile terminal 10 from the application screen page 1100 to the application screen page 1110 for viewing parking area information by performing an operation to select and confirm the selection of the parking area information viewing button 1102.

As illustrated in FIG. 11B, the application screen page 1110 includes a map image display area 1111, a parking area general information display area 1112, and a detail display button 1113.

The map image display area 1111 displays a map image in the vicinity of the destination of a car included in the route candidate displayed in the application screen page 1100 and also displays mark images 1111A representing the positions of parking areas in the map image in a superposing manner.

The parking area general information display area 1112 is superposed at the lower end of the map image display area 1111. The parking area general information display area 1112 displays parking area general information (for example, the parking area facility name, the usable available time slot, the total numbers of parking spaces, the fare, and so forth) selected from among the parking areas indicated by the mark images 1111A in the map image.

The user can display the parking area general information corresponding to a selected mark image 1111A on the parking area general information display area 1112 by performing an operation to select and confirm the selection of the mark image 1111A from the map image through the input device 17 of the mobile terminal 10.

The detail display button 1113 is used to display details of the parking area for which the general information is displayed on the parking area general information display area 1112 on the display device 16 of the mobile terminal 10. This allows the user to perform an operation to select and confirm the selection of the detail display button 1113 to view details of the parking area.

Thus, without, for example, activating a browser, a dedicated application or the like in the mobile terminal 10 to access parking area information by himself or herself, a user can view parking area information through operations on the application screen pages 1100 and 1110 for displaying information concerning a route candidate using a car included in a multimodal route search result. Thus, the convenience of the user can be improved.

The parking area information viewing button 1102 may be displayed also in a rental car or car sharing usage section of an application screen page which displays details of a route candidate using a rental car or car sharing. Thus, the user can view parking area information through operations on application screen pages for displaying information concerning a route candidate using a rental car or car sharing included in a multimodal route search result. Thus, the convenience of the user can be improved.

### [Method to Use Bicycle Sharing]

Next, a method to use bicycle sharing in response to user's operations on application screen pages of the route search application will be described later with reference to FIGS. 12A and 12B.

FIGS. 12A and 12B illustrate an example of a method to use bicycle sharing on the basis of a multimodal route search result. Specifically, FIG. 12A illustrates an example of an application screen page (an application screen page 1200) for displaying detailed contents of a route candidate using bicycle sharing from among a plurality of route candidates of a multimodal route search result. FIG. 12B illustrates an example of an application screen page (an application screen page 1210) for a user to use bicycle sharing.

As illustrated in FIG. 12A, the application screen page 1200 includes a route candidate detail display area 1201 as in the case of the application screen page 810 of FIG. 8B.

The route candidate detail display area 1201 displays route candidate details including a bicycle sharing usage section; an available bicycle checking button 1202 is provided in the bicycle sharing usage section. The user can change the display contents of the display device 16 of the mobile terminal 10 from the application screen page 1200 to the application screen page 1210 for reading information concerning available bicycles at the bicycle sharing cycle port (hereinafter, “available bicycle information”) by performing an operation to select and confirm the selection of the available bicycle checking button 1202.

As illustrated in FIG. 12B, the application screen page 1210 includes a map image display area 1211, a cycle port information display area 1212, and a use button 1213.

The map image display area 1211 displays a map image in the vicinity of the departure point of bicycle sharing included in the route candidate displayed in the application screen page 1200; mark images 1211A representing the positions of cycle ports are superposed on the map image.

The cycle port information display area 1212 is superposed at the lower end of the map image display area 1211. The cycle port information display area 1212 displays information (hereinafter, “cycle port information”) (for example, the name of the cycle port, the available time slot, the nearest facility, available bicycle information such as the number of available bicycles, and so forth) of the cycle port selected from among the cycle ports represented by the mark images 1211A in the map image.

The user may display the cycle port information corresponding to the selected mark image 1211A on the cycle port information display area 1212 by performing an operation to select and confirm the selection of the mark image 1211A from the map image through the input device 17 of the mobile terminal 10.

The use button 1213 is used to actually use a share bicycle of the cycle port for which the cycle port information is displayed in the cycle port information display area 1212. In more detail, as a result of the user performing an operation to select and confirm the selection of the use button 1213, the mobile terminal 10 activates an application (hereinafter, referred to as a “bicycle sharing application”) for using bicycle sharing installed in the auxiliary storage device 12, activates a browser to access a bicycle sharing web page, or the like. Then, the mobile terminal 10 inputs information concerning the cycle port that the user wants to use to the cycle share application or the like. Thus, the user can use bicycle sharing through operations on the bicycle sharing application, the bicycle sharing web page, or the like.

Thus, a user need not access information concerning bicycle sharing by, for example, activating a browser, a dedicated application, or the like in the mobile terminal 10. Thus, the multimodal route providing system 1 (the route search application installed in the mobile terminal 10) can assist a user to use bicycle sharing in response to the user's operations on the application screen pages 1200 and 1210 for displaying information concerning a route candidate using bicycle sharing included in a multimodal route search result.

The multimodal route providing system 1 (the route search application installed in the mobile terminal 10) may assist a user to use also a taxis, ride sharing, a rental car, car sharing, or the like in the same manner as in the case of bicycle sharing through the user's operations on application screen pages for displaying information concerning a corresponding route candidate of a multimodal route search result.

### [Method to View Fixed Route Bus Location Information and Method of Purchasing and Using Fixed Route Bus Ticket]

Referring now to FIGS. 13A and 13B, a method to view fixed route bus location information and a method of purchasing and using a fixed route bus ticket in response to user's operations on application screen pages of the route search application will now be described.

FIGS. 13A and 13B illustrate an example of a method to view fixed route bus location information and a method of purchasing and using a fixed route bus ticket on the basis of a multimodal route search result. FIG. 13A illustrates an example of an application screen page (an application screen page 1300) for displaying details of a route candidate using a fixed route bus from among a plurality of route candidates of a multimodal route search result. FIG. 13B illustrates an example of fixed route bus ticket information (fixed route bus 6-hour pass image information 1310) displayed on the display device 16 of the mobile terminal 10.

As illustrated in FIG. 13A, the application screen page 1300 includes a route candidate detail display area 1301 as in the case of the application screen page 810 of FIG. 8B.

The route candidate detail display area 1301 displays details of a route candidate including a fixed route bus usage section; a fixed route bus location information viewing button 1302 and a fixed route bus ticket purchase button 1303 are provided in the fixed route bus usage section.

The user can change the display contents of the display device 16 of the mobile terminal 10 from the application screen page 1300 to an application screen page (a fixed route bus location information screen page) for displaying fixed route bus location information for the fixed route bus used in the route candidate by performing an operation to select and confirm the selection of the fixed route bus location information viewing button 1302.

The fixed route bus location information screen page displays, for example, a map image for an area including the route of the fixed route bus used in the route candidate displayed in the application screen page 1300. In the map image, the route of the fixed route bus of the route candidate and the getting-on bus stop on the route of the route candidate as well as present location information and scheduled location information of the fixed route bus may be displayed in a superposed manner. In addition, in the map image, delay condition information of the fixed route bus (for example, text information such as “on schedule”, “delayed by xx minutes from the schedule”, or the like) may be superposed in such a manner as to be associated with the present location information of the fixed route bus.

Thus, the user can view the fixed route bus location information through the user's operations onto the application screen page 1300 displaying information concerning the route candidate using the fixed route bus in the multimodal route search result; and need not, for example, activate a browser or the like in the mobile terminal 10 to access fixed route bus location information by himself/herself. In addition, the user can know whether the fixed route bus will arrive as scheduled according to the departure time included in the route candidate or is delayed, by reading the present location information, the scheduled location information, the delay condition information, and so forth of the fixed route bus, to be used to, for example, determine whether to select the route candidate.

The user may perform an operation to select and confirm the selection of the fixed route bus ticket purchase button 1303 so as to change the display contents of the display device 16 of the mobile terminal 10 from the application screen page 1300 to an application screen page (a fixed route bus ticket purchase screen page) for purchasing a predetermined ticket for a fixed route bus, i.e., a 6-hour pass. A 6-hour pass for a fixed route bus is, for example, a specified time-limited ticket that allows a user to get off fixed route buses freely for 6 hours within a predetermined geographical area (for example, within a particular municipality) assuming a payment system such that a user makes a payment upon getting off a bus (the same payment system applying also hereinafter for fixed route buses).

Therefore, the user can transmit, through the mobile terminal 10, a bus ticket purchase request to the center server 20 by performing a predetermined operation on the fixed route bus ticket purchase screen page through the input device 17 of the mobile terminal 10 and purchase a 6-hour pass. The user can then use the fixed route bus by performing a predetermined operation on the predetermined application screen page of the route search application to display on the display device 16 of the mobile terminal 10 the fixed route bus ticket information (the 6-hour pass image information 1310) corresponding to the 6-hour pass delivered from the center server 20 to the mobile terminal 10 and stored in the fixed route bus ticket information storage unit 105 and showing the displayed information to the driver, conductor, or the like of the fixed route bus, for example.

As illustrated in FIG. 13B, the 6-hour pass image information 1310 for a fixed route bus displayed on the display device 16 is superposed with expiration information 1311, remaining time information 1312, and current time information 1313.

The expiration information 1311 represents the expiration of the 6-hour pass for a fixed route bus as a specified time-limited ticket.

The remaining time information 1312 represents the remaining time to the expiration of the 6-hour pass. The remaining time information 1312 is dynamically displayed in a countdown format and, in response to the expiration, turns into information indicating that the expiration has come. Thus, the application screen page displayed on the display device 16 of the mobile terminal dynamically displays not only the fixed route bus ticket information but also the remaining time to the expiration. Therefore, it is possible to inhibit unauthorized usage of the fixed route bus ticket information corresponding to a specified time-limited ticket otherwise occurring with the use of a captured image of the application screen page, for example.

The current time information 1313 represents the current time and is displayed dynamically in a counting-up format. Thus the current time is dynamically displayed in addition to the fixed route bus ticket information on the application screen page displayed on the display device 16 of the mobile terminal 10. Therefore, it is possible to inhibit unauthorized usage of the fixed route bus ticket information corresponding to a specified time-limited ticket otherwise occurring with the use of a captured image of the application screen page, for example.

Thus, a user can purchase and use a predetermined ticket (for example, a 6-hour pass) for a fixed route bus using the mobile terminal 10 by continuously using the route search application. Thus, the convenience of the user can be improved.

The mobile terminal 10 may perform a process concerning purchase of a predetermined ticket of a fixed route bus or may perform a process for displaying fixed route bus ticket information on the display device 16 in response to user's operation without using an application screen page of the route search application.

For example, the mobile terminal 10 activates an application provided by a fixed route bus related server 30 (hereinafter, referred to as a “fixed route bus application”) and transmits a bus ticket purchase request to the fixed route bus related server 30 in response to user's predetermined operations on a predetermined application screen page of the fixed route bus application. Then, the mobile terminal 10 may display fixed route bus ticket information delivered from the fixed route bus related server 30 on the display device 16 in response to user's predetermined operations on a predetermined application screen page of the fixed route bus application.

Alternatively, in response to user's predetermined operations on a web page (hereinafter, a “fixed route bus page”) for a fixed route bus provided by the fixed route bus related server 30 or the like, for example, which is accessed through a browser, the mobile terminal 10 performs a process concerning purchase of a predetermined ticket for a fixed route bus using the fixed route bus page. Then, the mobile terminal 10 may display fixed route bus ticket information transmitted as a web resource from the fixed route bus related server 30 to the browser in response to user's predetermined operations on the fixed route bus page accessed through the browser. In this regard, the user can access the fixed route bus page through the browser installed in the mobile terminal 10; under the control of the fixed route bus related server 30, the user can purchase a predetermined ticket for a fixed route bus or display fixed route bus ticket information corresponding to the purchased ticket, through the browser of the mobile terminal 10.

Also for another type of transportation (for example, public transportation such as a train, an expressway bus, a ship, an airplane, or the like) for which the operation schedule including the route and time of operation is previously determined, the mobile terminal may enable a user's purchase and use of a ticket in the same manner as the case for a fixed route bus described above.

### [Fixed Route Bus Ticket Information Display Process]

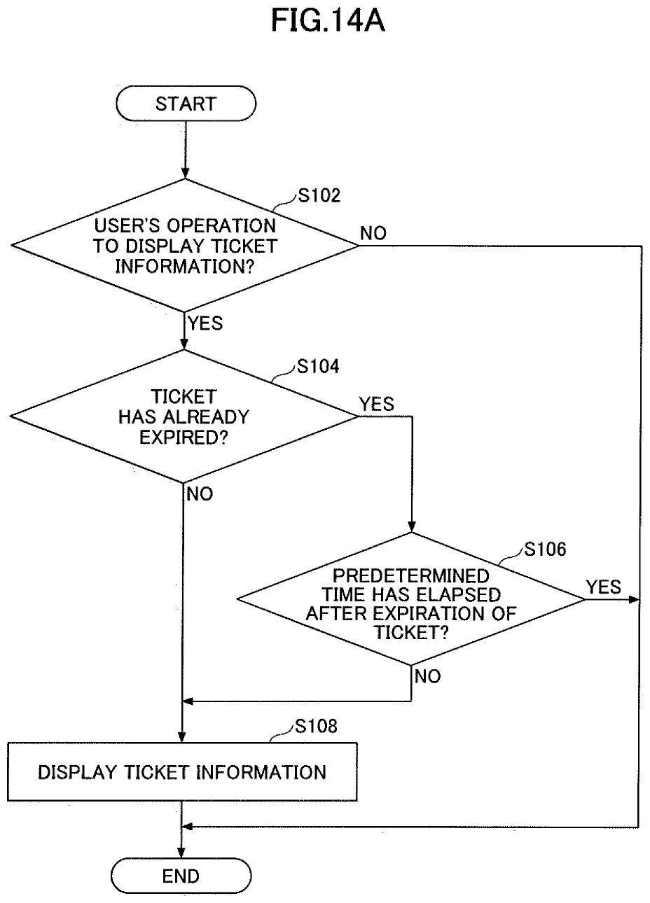

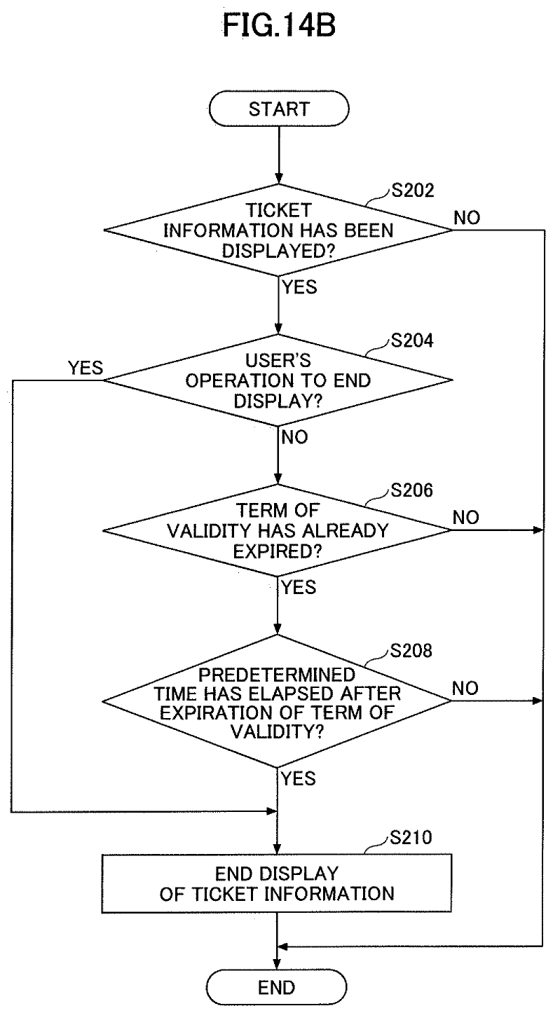

With reference to FIGS. 14A and 14B, a process (hereinafter, referred to as a “fixed route bus ticket information display process”) for displaying fixed route bus ticket information corresponding to a specified time-limited ticket performed by the mobile terminal 10 (the fixed route bus ticket usage assist process unit 104) onto the display device 16 of the mobile terminal 10 will now be described.

FIGS. 14A and 14B are flowcharts schematically illustrating an example of a fixed route bus ticket information display process performed by the mobile terminal 10 (the fixed route bus ticket usage assist process unit 104). A process flow illustrated in the flowchart of FIG. 14A is executed, for example, every predetermined control cycle in a condition where, after the route search application of the mobile terminal 10 is activated, information of a specific time-limited ticket for a fixed route bus (for example, the fixed route bus 6-hour pass image information 1310 of FIG. 13B) has not been displayed. A process flow illustrated in the flow chart of FIG. 14B is executed, for example, every predetermined control cycle in a condition where, after the route search application of the mobile terminal 10 is activated, information of a specific time-limited ticket for a fixed route bus has been displayed.

First, as illustrated in FIG. 14A, in step S102, the fixed route bus ticket usage assist process unit 104 determines whether an operation to display fixed route bus ticket information corresponding to a specified time-limited ticket for a fixed route bus is performed through the input device 17. In response to the operation having been performed, the fixed route bus ticket usage assist process unit 104 proceeds to step S104. In response to the operation not having been performed, the fixed route bus ticket usage assist process unit 104 ends the current process.

In step S104, the fixed route bus ticket usage assist process unit 104 determines whether the specified time-limited ticket for a fixed route bus has expired. The fixed route bus ticket usage assist process unit 104 proceeds to step S106 in response to the expiration of the specified time-limited ticket for a fixed route bus. The fixed route bus ticket usage assist process unit 104 proceeds to step S108 in a case where the specified time-limited ticket has not expired yet.

In step S106, the fixed route bus ticket usage assist process unit 104 determines whether a predetermined time T1 has elapsed after the specified time-limited ticket for a fixed route bus has expired. The fixed route bus ticket usage assist process unit 104 proceeds to step S108 in a case where the predetermined time T1 has not elapsed yet after the expiration of the specified time-limited ticket for a fixed route bus. The fixed route bus ticket usage assist process unit 104 ends the current process in response to the elapse of the predetermined time T1 after the expiration of the specified time-limited ticket for a fixed route bus.

In step S108, the fixed route bus ticket usage assist process unit 104 displays the fixed route bus ticket information corresponding to the specified time-limited ticket on the display device 16 and ends the current process.

The flowchart of FIG. 14B will now be described. In step S202, the fixed route bus ticket usage assist process unit 104 determines whether fixed route bus ticket information corresponding to a specified time-limited ticket for a fixed route bus has been displayed on the display device 16. In a case where fixed route bus ticket information corresponding to a specified time-limited ticket for a fixed route bus has been displayed on the display device 16, the fixed route bus ticket usage assist process unit 104 proceeds to step S204. In a case where a fixed route bus ticket information corresponding to a specified time-limited ticket for a fixed route bus has not been displayed on the display device 16, the fixed route bus ticket usage assist process unit 104 ends the current process.

In step S204, the fixed route bus ticket usage assist process unit 104 determines whether an operation to terminate the display of the fixed route bus ticket information has been performed through the input device 17. In a case where the operation has not been performed, the fixed route bus ticket usage assist process unit 104 proceeds to step S206. In a case where the operation has been performed, the fixed route bus ticket usage assist process unit 104 proceeds to step S210.

In step S206, the fixed route bus ticket usage assist process unit 104 determines whether the specified time-limited ticket for a fixed route bus has expired. The fixed route bus ticket usage assist process unit 104 proceeds to step S208 in response to the expiration of the specified time-limited ticket for a fixed route bus. In a case where the specified time-limited ticket for a fixed route bus has not expired, the fixed route bus ticket usage assist process unit 104 ends the current process.

In step S208, the fixed route bus ticket usage assist process unit 104 determines whether the predetermined time T1 has elapsed after the expiration of the specified time-limited ticket for a fixed route bus. The fixed route bus ticket usage assist process unit 104 proceeds to step S210 in response to the elapse of the predetermined time T1 after the expiration of the specified time-limited ticket for a fixed route bus. The fixed route bus ticket usage assist process unit 104 ends the current process in a case where the predetermined time T1 has not elapsed after the expiration of the specified time-limited ticket for a fixed route bus.

In step S210, the fixed route bus ticket usage assist process unit 104 stops (terminates) the display of the fixed route bus ticket information corresponding to the specified time-limited ticket for a fixed route bus on the display device 16 and ends the current process.

Thus, in this example, the fixed route bus ticket usage assist process unit 104 causes the display device 16 to continue displaying fixed route bus ticket information corresponding to a specified time-limited ticket until the predetermined time T1 elapses after the expiration of the specified time-limited ticket; and prevents the display device 16 from displaying the fixed route bus ticket information in response to the elapse of the predetermined time T1 after the expiration of the specified time-limited ticket.

In more detail, until the predetermined time T1 has elapsed after the expiration of the specified time-limited ticket, the fixed route bus ticket usage assist process unit 104 displays the fixed route bus ticket information corresponding to the specified time-limited ticket on the display device 16 in response to a user's predetermined operation, and continues displaying the fixed route bus ticket information displayed on the display device 16. In contrast thereto, after the elapse of the predetermined time T1 after the expiration of the specified time-limited ticket, the fixed route bus ticket usage assist process unit 104 does not display the fixed route bus ticket information on the display device 16 even in response to a user's predetermined operation and terminates a display of the fixed route bus ticket information, if any, on the display device 16.

Thus, while it is a basic process manner of the mobile terminal 10 to prevent displaying fixed route bus ticket information after the expiration of a specified time-limited ticket, the portable terminal 10 can delay terminating a display of the fixed route bus ticket information after the specified time-limited ticket expires. Therefore, for example, in a case where a fixed route bus has arrived late at a bus stop and thus a specified time-limited ticket expires, the user can prove that he/she is a purchaser of the specified time-limited ticket and negotiate with the driver, conductor, or the like to get off the bus without paying an additional fare on the grounds of the delay. Thus, the mobile terminal 10 can improve the convenience of a user when the user uses a specific time-limited ticket while inhibiting an unauthorized usage of a specific time-limited ticket provided to the mobile terminal 10 of a user.

The predetermined time T1 may be a predetermined fixed time, for example, 30 minutes.

The predetermined time T1 may be changed according to, for example, an actual operation state or an estimated operation state of a fixed route bus with a user aboard. In more detail, in a case where a user is currently in a fixed route bus when a specified time-limited ticket has expired, the predetermined time T1 may be set longer as the actual delay time or an estimated delay time of the bus to the operation schedule is longer.

Thus, the mobile terminal 10 can delay terminating a display of fixed route bus ticket information on the display device 16 after the expiration of a specified time-limited ticket according to an actual or estimated delay condition of a vehicle (a fixed route bus) with the user aboard. Thus, the mobile terminal 10 can achieve both inhibiting an unauthorized usage of a time-limited ticket and improving the convenience of a user when the user uses a time-limited ticket, more appropriately.

In this regard, the mobile terminal 10 can access the fixed route bus related server 30 directly or via the center server 20 to know the delay condition of a fixed route bus, fixed route bus location information, and so forth. The mobile terminal 10 thus compares the positioning history information of the GNSS device mounted in the mobile terminal 10 with the present location information of a fixed route bus, so as to identify the fixed route bus with the user aboard and obtain information of the delay condition of the fixed route bus.

Alternatively, the mobile terminal 10 may identify the fixed route bus with the user aboard on the basis of a route candidate selected by the user from among a plurality of route candidates of a multimodal route search result (for example, the route candidate for which route guidance has been performed, the route candidate for which the user repeatedly displays the details, or the like).

Further alternatively, pairing may be performed between a communication device mounted in the mobile terminal 10 and a communication device mounted in the fixed route bus through predetermined short-distance communication (for example, WiFi or Bluetooth (both are registered trademarks)), and the pairing information may be transmitted to the mobile terminal 10 via the fixed route bus related server 30, so that the mobile terminal can identify the fixed route bus with the user aboard.

The mobile terminal 10 may estimate the delay time of the fixed route bus on the basis of history information of past operation states of fixed route buses having the same time schedule on different dates obtainable from the fixed route bus related server 30.

As described above, the fixed route bus ticket usage assist process unit 104 displays the remaining time to the expiration of a specified time-limited ticket together with the corresponding fixed route bus ticket information on the display device 16 for a case where the specified time-limited ticket has not expired. The fixed route bus ticket usage assist process unit 104 may display information indicating that the specified time-limited ticket has expired, instead of the remaining time in the countdown format, together with the corresponding fixed route bus ticket information, after the expiration of the specified time-limited ticket.

Thus, a screen page of the mobile terminal 10 displays not only fixed route bus ticket information but also the remaining time to the expiration dynamically. Therefore, a predetermined person such as the driver, conductor, or the like of a fixed route bus can easily determine whether the fixed route bus ticket information corresponds to the expired time-limited ticket. Thus, it is possible to inhibit a fraud of, for example, displaying expired fixed route bus ticket information to the driver, conductor, or the like on the mobile terminal 10 to get off a fixed route bus without paying an additional fare although no delay has occurred in the fixed route bus, for example.

For a case where a similar specific time-limited ticket is provided (delivered) to the mobile terminal 10 for a type of transportation other than a fixed route bus (for example, public transportation such as a train, an expressway bus, a ship, or an airplane) for which an operation schedule including the route and the time of operation is predetermined, a process of displaying ticket information corresponding to a specified time-limited ticket may be performed in the same manner as for a fixed route bus. As a result, for a case of a predetermined type of transportation other than a fixed route bus, the same effect as in the case of a fixed route bus is obtainable.

For example, the display contents of fixed route bus ticket information on an application screen page of a fixed route bus application or on a fixed route bus page of a browser may be controlled by the center server 20. Therefore, in this case, a process of displaying the fixed route bus ticket information may be performed by the center server 20.

### [Method to Generate Macro Data]

A method to generate macro data on the basis of history data of multimodal route search results will now be described with reference to FIGS. 15A and 15B and FIGS. 16A-16D.

First, FIGS. 15A and 15B illustrate examples of history data of multimodal route search results, that is, a record group of past multimodal route search results, stored in the route search result history storage unit 207.

As illustrated in FIGS. 15A and 15B, each record of multimodal route search results includes, for a route search request, data such as the user ID; the departure point; the via-point; information as to whether the route search request is a request through event information or spot information obtained on the basis of a spot/event search (“via event/spot information” in the figures); information concerning the output (provided) route candidates; information concerning the selected route candidate (hereinafter, a “selected route”); information as to whether something has been used or checked in advance; and so forth.

The information concerning the output route candidates includes information as to which types of transportation are used in the route candidates output as a multimodal route search result.

The information concerning the output route candidates further includes information as to whether the types of transportation used in the route candidates output as the multimodal route search result are used because they are relatively convenient (“more convenient” in the figures) or are used regardless of whether they are convenient (“less convenient” in the drawings).

Conditions for determining whether a type of transportation is relatively convenient may include, for example, whether the type of transportation requires a relatively short transfer waiting time (specifically, whether the type of transportation requires the transfer waiting time shorter than a predetermined threshold), whether the type of transportation requires a relatively short walking time (specifically, whether the type of transportation requires the walking time shorter than a predetermined threshold), whether the type of transportation requires a relatively low fare (specifically, whether the type of transportation requires the fare lower than a predetermined threshold), or the like.

The information concerning a selected route is information as to which type of transportation is used in a route candidate selected by a user from among route candidates.

A route candidate selected by a user from among route candidates of a multimodal route search result may be, for example, a route candidate for which the above-described route guidance is executed or a route candidate for which the number of displaying times or display time length of detailed information is equal to or more than a predetermined threshold among the route candidates of the multimodal route search result.

The information as to whether something has been used or checked in advance is information as to whether an assist service (for example, accessing fixed route bus location information, purchasing a predetermined ticket for a fixed route bus, a taxi reservation, assisting a user to use bicycle sharing, viewing parking area information, or the like) has been used on the basis of a multimodal route search result.

The macro data generating unit 206 generates macro data on the basis of the record group stored in the route search result history storage unit 207.

FIGS. 16A-16D illustrate macro data. FIGS. 16A and 16B illustrate macro data conceptually; FIGS. 16C and 16D illustrate an example of macro data.

In more detail, the bar graphs for the particular types of transportation corresponding to ‘(1) route search “which routes are available”’ in FIGS. 16A and 16B schematically represent the total numbers of route search requests that satisfy certain conditions (hereinafter, “the total numbers of route search requests”).

The bar graphs for the particular types of transportation corresponding to ‘(2) route search “some routes are available”’ in FIGS. 16A and 16B schematically represent the numbers of times of the particular types of transportation being used in route candidates of multimodal route search results in the total number of route search requests (hereinafter, “the numbers of times of being used in route candidates”).

The bar graph for the particular types of transportation corresponding to ‘(3) display details “this route will be used”’ in FIGS. 16A and 16B schematically represent the numbers of times of the particular types of transportation being used in selected routes in the total number of route search requests (hereinafter, “the numbers of times of being used as selected routes”).

The bar graphs for the particular types of transportation corresponding to ‘(4) start guidance’ in FIGS. 16A and 16B schematically represent the numbers of times of actually performed route guidance for selected routes using the particular types of transportation in the total number of route search requests (hereinafter, “the numbers of times of route guidance”).

The bar graphs for the particular types of transportation corresponding to ‘(5) reservation, advance check, or the like’ in FIGS. 16A and 16B represent the numbers of times of assist services used on the basis of multimodal route search results of (for example, viewing fixed route bus location information, purchasing a predetermined ticket for a fixed route bus, a reservation of a taxi, assisting a user to use bicycle sharing, viewing parking area information, and so forth) in the total number of route search requests (hereinafter referred to as “the numbers of times of reservation or advance check being used”).

The bar graphs for the particular types of transportation corresponding to ‘(6) used (paid) “actually moved”’ in FIGS. 16A and 16B represent the numbers of times of the particular types of transportation having been used for actual moving in the total number of route search requests (hereinafter, “the numbers of times of moving”).

The bar graphs for the particular types of transportation corresponding to ‘(7) plurality of times of usage “used again” in FIGS. 16A and 16B″ represent the numbers of users (hereinafter, “multiple-use users”) each of whom has moved with a particular type of transportation a plurality of times in the total number of route search requests.

In order to calculate the values of the bar graphs drawn by the broken lines in FIGS. 16A and 16B, it is necessary to obtain data from outside of the multimodal route providing system 1.

For example, as illustrated in FIG. 16A, the rates of the particular types of transportation having been used in the output route candidates with respect to the group of route search requests (that is, the rates of the numbers of times at which the particular types of transportation have been used in the route candidates with respect to the total number of route search requests) are understandable to represent the extents to which the particular types of transportation have potentials to contribute to users’ needs to move (a “supply rate” of a particular type of transportation illustrated in FIG. 16A).

Therefore, the macro data generating unit 206 may calculate the supply rates of the particular types of transportation, for example, on a per-combination of a departure point area and a destination area basis, and generate macro data including the calculation results (see FIG. 16C).

Thus, the administrator or the operator of the center server 20 (hereinafter, referred to as the “administrator or the like”) can know the supply rates calculated on a per-type of transportation basis and on the per-combination of a departure point area and a destination area basis.

For example, combinations of departure point areas and destination areas may be determined as a result of grid-like square-shaped areas each having a predetermined size (for example, 500 meters by 500 meters) defined in an area to be analyzed (hereinafter, a “to-be-analyzed area”) included in the route search subject area being set as departure point areas and destination areas.

Similarly, the rates of the particular types of transportation having been used in the selected routes with respect to the group of route search requests (that is, the rates of the numbers of times at which the particular types of transportation have been used in the selected routes with respect to the total number of route search requests) are understandable to represent the extents to which the particular types of transportation are demanded as users' needs to move (a “demanded rate” of a particular type of transportation illustrated in FIG. 16A).

Therefore, the macro data generating unit 206 may calculate the demanded rates of the particular types of transportation, for example, on the per-combination of a departure point area and a destination area basis, and generate macro data including the calculation results (see FIG. 16D).

Thus, the administrator or the like of the center server 20 can know the demanded rate calculated on the per-type of transportation basis and on the per-combination of a departure point area and a destination area basis.

The rate of the route search requests for which viewing services for fixed route bus location information have been used with respect to the search requests for which the route candidates using fixed route buses have been selected by users among the group of route search requests (that is, the rate of the number of times of reservation or advance check that is of viewing services for fixed route bus location information being used with respect to the number of times of fixed route buses being used in the selected routes) is understandable to represent the rate of viewing services for fixed route bus location information being used (a “used rate” of a particular type of transportation illustrated in FIG. 16A).

Therefore, the macro data generating unit 206 may calculate the rate of the route search requests for which viewing services for fixed route bus location information have been used with respect to the search requests for which the route candidates using fixed route buses have been selected by users among the group of route search requests and generate macro data including the calculation result.

Thus, the administrator or the like of the center server 20 can know the rate of viewing services for fixed route bus location information being used.

The rate of the route search requests for which purchasing services for fixed route bus tickets have been used with respect to the search requests for which the route candidates using fixed route buses have been selected by users among the group of route search requests (that is, the rate of the number of times of reservation or advance check that is of purchasing services for fixed route bus tickets being used with respect to the number of times of fixed route buses being used in the selected routes) or the actual number of the same (i.e., the number of times of reservation or advance check that is of purchasing services for fixed route bus tickets being used) is understandable to represent the rate of fixed route bus tickets being used or the sales of fixed route bus tickets through the route search application.

Therefore, the macro data generating unit 206 may calculate the rate of the route search requests for which purchasing services for fixed route bus tickets have been used with respect to the search requests for which the route candidates using fixed route buses have been selected by users among the group of route search requests or the actual number of the same and generate macro data including the calculation result.

Thus, the administrator or the like of the center server 20 can know the rate of fixed route bus tickets being used or the sales of fixed route bus tickets through the route search application.

The rate of the route search requests for which taxi reservation services have been used with respect to the search requests for which the route candidates using taxies have been selected by users among the group of route search requests (that is, the rate of the number of times of reservation or advance check that is of taxi reservation services being used with respect to the number of times of taxies being used in the selected routes) is understandable to represent the rate of taxi reservation services leading users to reserve or use taxies (i.e., a “leading rate”).

Therefore, the macro data generating unit 206 may calculate the rate of the route search requests for which taxi reservation services have been used with respect to the search requests for which the route candidates using taxies have been selected by users among the group of route search requests and generate macro data including the calculation result.

Thus, the administrator or the like of the center server 20 can know the rate of taxi reservation services leading users to reserve or use taxies (the leading rate).

The rate of the route search requests for which bicycle sharing assist services have been used with respect to the search requests for which the route candidates using bicycle sharing have been selected by users among the group of route search requests (that is, the rate of the number of times of reservation or advance check that is of bicycle sharing usage assist services being used with respect to the number of times of bicycle sharing being used in the selected routes) is understandable to represent the rate of bicycle sharing usage assist services leading users to use bicycle sharing (i.e., a “leading rate”).

Therefore, the macro data generating unit 206 may calculate the rate of the route search requests for which bicycle sharing usage assist services have been used with respect to the search requests for which the route candidates using bicycle sharing have been selected by users among the group of route search requests and generate macro data including the calculation result.

Thus, the administrator or the like of the center server 20 can know, on the basis of the macro data, the rate of bicycle sharing usage assist services leading users to use bicycle sharing (the leading rate).

In addition, the rate of the route search requests for which viewing services for parking area information have been used with respect to the search requests for which the route candidates using cars have been selected by users among the group of route search requests (that is, the rate of the number of times of reservation or advance check that is of viewing services for parking area information being used with respect to the number of times of cars being used in the selected routes) is understandable to represent the rate of viewing services for parking area information leading users to use parking areas (i.e., a “leading rate”).

Therefore, the macro data generating unit 206 may calculate the rate of the route search requests for which viewing services for parking area information have been used with respect to the search requests for which the route candidates using cars have been selected by users among the group of route search requests and generate macro data including the calculation result.

Thus, the administrator or the like of the center server 20 can know the rate of viewing services for parking area information leading users to use parking areas (the leading rate).

For example, as illustrated in FIG. 16B, attribute classifications of users who have selected candidate routes using a particular type of transportation (in FIG. 16B, fixed route buses) may be performed. Thereby, it is possible to know what attribute classifications categorize the users who have selected candidate routes using a particular type of transportation.

In more detail, the macro data generating unit 206 may calculate the percentages of the genders and ages; the percentages of living areas such as persons who live in Japan or inbound tourists and persons who live in towns or out-of-town; the percentages of persons who have cars or not; the percentages of persons who have commuter tickets or not; and so forth, and generate macro data including the calculation results. At this time, the macro data generating unit 206 may calculate these percentages on a per-combination of departure point area and destination area basis as in the case of supply rates or demanded rates of particular types of transportation. Thus, the administrator or the like of the center server can know the attribute classifications (attribute percentages) on a per-type of transportation basis and on a per-combination of departure point area and destination area basis.

Such attribute information of users on a per-user basis (for example, gender, age, living area, having or not having a car, having or not having a commuter pass, and so forth) may be stored, for example, in the auxiliary storage device 22 or an external storage device communicatively connected with the center server 20 in a manner being associated with user identification information (for example, a user ID). Thus, the macro data generating unit 206 can read the attribute information of each user and generate the above-described macro data.

Thus, on the basis of history data of multimodal route search results, the macro data generating unit 206 calculates, on a per-type of transportation basis and on a per-combination of departure point area and destination area basis, at least one type of rates from among a first type of rates (i.e., supply rates) of particular types of transportation being used in route candidates provided in each of route search results with respect to a group of route search requests corresponding to combinations of departure point areas and destination areas and a second type of rates (i.e., demanded rates) of the particular types of transportation being used in route candidates (i.e., selected routes) each selected by a user from among the route candidates provided in each of the route search results with respect to the group of route search requests. Then, the macro data generating unit 206 generates, on the per-combination of departure point area and destination area basis, macro data where departure point areas and destination areas are associated with, on the per-type of transportation basis, at least one type of rates from among the first type of rates (the supply rates) and the second type of rates (the demanded rates).

Thus, the center server 20 can generate macro data corresponding to the extents to which the particular types of transportation can support needs to move of a plurality of users from departure point areas to destination areas. The center server 20 can also generate macro data as to which types of transportation the users tend to select for their needs to move from departure point areas to destination areas. Thus, the center server can generate output data (macro data) for enabling to know various tendencies concerning moving of the users from a macro viewpoint from history data of multimodal route search results corresponding to requests from the users.

The macro data generating unit 206 may generate, on the per-combination of departure point area and destination area basis, macro data where the departure point areas and the destination areas are associated with, on the per-type of transportation basis, information concerning attributes of users who have selected the route candidates that use the plurality of types of transportation (or have selected the plurality of types of transportation by selecting the corresponding route candidates), each of the route candidates having been selected from among the route candidates included in each of the route search results of the group of route search requests corresponding to the combinations of the departure point areas and the destination areas.

This allows the center server 20 to generate macro data as to the attributes of the users who have selected the particular types of transportation for the plurality of needs to move from the departure point areas to the destination areas.

The information concerning the attributes of the users who have selected the route candidates that use the types of transportation (or have selected the types of transportation by selecting the corresponding route candidates), each of the route candidates having been selected from among the route candidates included in each of the route search results of the group of route search requests corresponding to the combinations of the departure point areas and the destination areas, may include information concerning a set of rates from among a set of genders, a set of ages, a set of living areas, a set of states of having and not having cars, and a set of states of having and not having commuter tickets from departure point areas to destination areas of corresponding types of transportation.

This allows the center server 20 to generate, on a per-particular user attribute classification basis, macro data as to the attributes of the users who have selected the particular types of transportation for the plurality of needs to move from the departure point areas to the destination areas.

Thus, the data generating apparatuses, the data generating systems, the data generating methods, and the non-transitory recording media have been described with reference to the embodiments. In this regard, the present invention is not limited to the specifically disclosed embodiments, and variations and modifications may be made without departing from the scope of the claims.

The present application is based on and claims priority to Japanese patent application No. 2018-204544, filed on Oct. 30, 2018, the entire contents of which are hereby incorporated herein by reference.

What is claimed is:

1. A data generating apparatus comprising:
one or more processors configured to:
calculate,
on a basis of stored history information of route search results of route searches from departure points to destinations, each using one or more types of transportation from among a plurality of types of transportation, performed in response to route search requests respectively from a plurality of users and each including a departure point and a destination,
at least one type of rates from among a first type of rates and a second type of rates, each type of rates being rates with respect to route search requests corresponding to combinations of departure point areas and destination areas,
wherein
the first type of rates are respective rates of, on a per-combination of departure point area and destination area basis and on a per-type of transportation basis, the types of transportation being used in route candidates provided in each of route search results, and
the second type of rates are respective rates of, on the per-combination of departure point area and destination area basis and on the per-type of transportation basis, the types of transportation being used in route candidates each selected by a user from the route candidates provided in each of the route search results; and
generate, on the per-combination of departure point area and destination area basis, data where the departure point areas and the destination areas are associated with, on the per-type of transportation basis, the at least one type of rates from among the first type of rates and the second type of rates.

2. The data generating apparatus as claimed in claim 1, wherein
the one or more processors is further configured to
generate, on the per-combination of departure point area and destination area basis, data where the departure point areas and the destination areas are associated with, on the per-type of transportation basis, information concerning attributes of users who have selected the plurality of types of transportation that have been selected from the route search results of the route search requests corresponding to the combinations of the departure point areas and the destination areas.

3. The data generating apparatus as claimed in claim 2, wherein
the information concerning the attributes of the users who have selected the types of transportation that have been selected from the route search results of the route search requests corresponding to the combinations of departure point areas and destination areas, include information concerning a set of rates from among a set of genders, a set of ages, a set of living areas, a set of states of having and not having cars, and a set of states of having and not having commuter tickets from departure point areas to destination areas of corresponding types of transportation.

4. A data generating system comprising:
one or more processors configured to:
perform route searches for routes from departure points to destinations each using one or more types of types of transportation from among a plurality of types of transportation in response to route search requests, respectively from a plurality of users, each including a departure point and a destination;
store route search results of the route searches;
calculate, on a basis of the stored route search results, at least one type of rates from among a first type of rates and a second type of rates, each type of rates being rates with respect to route search requests corresponding to combinations of departure point areas and destination areas,
wherein
the first type of rates are respective rates of, on a per-combination of departure point area and destination area basis and on a per-type of transportation basis, the types of transportation being used in route candidates provided in each of route search results, and
the second type of rates are respective rates of, on the per-combination of departure point area and destination area basis and on the per-type of transportation basis, the types of transportation being used in route candidates each selected by a user from among route candidates provided in each of the route search results; and
generate, on the per-combination of departure point area and destination area basis, data where the departure point areas and the destination areas are associated with, on the per-type of transportation basis, the at least one type of rates from among the first type of rates and the second type of rates.

5. A data generating method comprising:
calculating, by one or more processors,
on a basis of stored history information of route search results of route searches from departure points to destinations, each using one or more types of transportation from among a plurality of types of transportation, performed in response to route search requests respectively from a plurality of users and each including a departure point and a destination,
at least one type of rates from among a first type of rates and a second type of rates, each type of rates being rates with respect to route search requests corresponding to combinations of departure point areas and destination areas,
wherein
the first type of rates are respective rates of, on a per-combination of departure point area and destination area basis and on a per-type of transportation basis, the types of transportation being used in route candidates provided in each of route search results, and
the second type of rates are respective rates of, on the per-combination of departure point area and destination area basis and on the per-type of transportation basis, the types of transportation being used in route candidates each selected by a user from among the route candidates provided in each of the route search results; and
generating, by one or more processors, on the per-combination of departure point area and destination area basis, data where the departure point areas and the destination areas are associated with, on the per-type of transportation basis, the at least one type of rates from among the first type of rates and the second type of rates.

6. A non-transitory recording medium storing therein a data generating program, the data generating program being configured to, when executed by one or more processors, implement the data generating method claimed in claim 5.
